(19) United States
(12) Patent Application Publication
(10) Pub. No.: US 2024/0162561 A1
(43) Pub. Date: May 16, 2024

(54) SEPARATOR FOR ELECTRIC STORAGE DEVICE AND ELECTRIC STORAGE DEVICE

(71) Applicants: Celgard, LLC, Charlotte, NC (US); ASAHI KASEI KABUSHIKI KAISHA, Tokyo (JP)

(72) Inventors: Shinya Hamasaki, Tokyo (JP); Yoko Azami, Tokyo (JP); Masaki Takahashi, Tokyo (JP); Hirotaka Yoshida, Tokyo (JP); Hisashi Takeda, Charlotte, NC (US)

(21) Appl. No.: 18/282,056

(22) PCT Filed: Mar. 14, 2022
(86) PCT No.: PCT/US2022/020154

§ 371 Date: Sep. 14, 2023

Related U.S. Application Data
(60) Provisional application No. 63/161,453, filed on Mar. 16, 2021.
(60) Provisional application No. 63/161,452, filed on Mar. 16, 2021.

(30) Foreign Application Priority Data
Jul. 29, 2021 (JP) 2021-124480
Jul. 29, 2021 (JP) 2021-124509

(51) Int. Cl. H01M 50/417; H01M 4/02; H01M 4/58; H01M 50/449; H01M 50/489

(52) U.S. Cl. CPC H01M 50/417; H01M 4/5825; H01M 50/449; H01M 50/489; H01M 2004/028

(57) ABSTRACT

The present disclosure provides a separator for an electric storage device, which separator is capable of reducing clogging and has an excellent thermal stability, and an electric storage device using the same. The above-described separator for an electric storage device includes a microporous layer (A) and a microporous layer (B) that contain 70 wt % or more of polypropylene, and the area average major pore diameter in an ND-MD cross section of the microporous layer (B) is not more than 0.95 times the area average major pore diameter in an ND-MD cross section of the microporous layer (A). Alternatively, the separator for an electric storage device contains 70% by weight or more of a polyolefin, and the area average major pore diameter of a first porous surface (X) of the separator is not less than 1.05 times and not more than 10 times the area average major pore diameter of a second porous surface (Y) on the side opposite thereto.

### RELATED APPLICATIONS

This application is a 371 U.S. Patent Application to PCT Application No. PCT/US2022/020154, filed Mar. 14, 2022, which claims priority to U.S. Provisional Application Nos. 63/161,453, filed Mar. 16, 2021, U.S. Provisional Application No. 63/161,452, filed Mar. 16, 2021, JP Application No. JP 2021-124480, filed Jul. 29, 2021; and JP Application No. JP 2021-124509, filed Jul. 29, 2021, which are incorporated herein by reference in their entireties.

### FIELD

The present disclosure relates to a separator for an electric storage device and an electric Fi

### BACKGROUND

Microporous membranes, particularly, polyolefin-based microporous membranes, are used in a wide range of technical fields, such as microfiltration membranes, separators for batteries, separators for capacitors, materials for fuel cells and the like, and used particularly as separators for secondary batteries typified by lithium-ion batteries. Lithium-ion batteries are used in various types of applications, for example, applications for small electronic devices such as mobile phones and laptop personal computers, as well as electric vehicles including hybrid cars and plug-in hybrid cars.

In recent years, lithium-ion batteries having a high energy capacity, a high energy density and high output characteristics are demanded. Along with such a tendency, demands for separators having a reduced thickness, an excellent battery performance as well as an excellent battery reliability and safety are increasing.

For example, Patent Literature 1 discloses a multilayer microporous thin film or membrane capable of showing improved characteristics including an improved dielectric breakdown and strength, as compared to a conventional single-layer or three-layer microporous membrane having the same thickness. A preferred multilayer microporous membrane includes a microlayer and one or more layered barriers.

Patent Literature 2 discloses a separator for an electric storage device, which includes a microporous membrane containing a polyolefin as a main component, wherein the microporous membrane has a melt tension, as measured at a temperature of 230° C., of 30 mN or less, and wherein the microporous membrane has a melt flow rate (MFR), as measured at a load of 2.16 kg and a temperature of 230° C., of 0.9 g/10 min or less.

### CITATION LIST

### Patent Literature

[PTL 1] WO 2018/089748
[PTL 2] WO 2020/196120

### SUMMARY

### Technical Problem

There are problems that deposits generated due to cycle deterioration cause clogging of separators, leading to a decrease in cycle life. Further, with an increase in battery size, separators capable of showing an excellent air permeability and dimensional stability even after being exposed to a high temperature are demanded.

Accordingly, an object of the present disclosure is to provide a separator for an electric storage device, which separator is capable of reducing clogging and has an excellent thermal stability, and an electric storage device using the same.

### Solution to Problem

Examples of embodiments of the present disclosure will be listed in the following items [1] to [22].

A separator for an electric storage device, comprising a substrate comprising:
a microporous layer (A) containing 70 wt % or more of polypropylene; and
a microporous layer (B) containing 70 wt % or more of polypropylene,
wherein the area average major pore diameter in an ND-MD cross section of the pores included in the microporous layer (B) is not more than 0.95 times the area average major pore diameter in an ND-MD cross section of the pores included in the microporous layer (A).

The separator for an electric storage device according to item 1, wherein the area average major pore diameter in an ND-MD cross section of the pores included in the microporous layer (B) is not less than 0.30 times and not more than 0.90 times the area average major pore diameter in an ND-MD cross section of the pores included in the microporous layer (A).

The separator for an electric storage device according to item 1 or 2, wherein the substrate has a rate of change in air permeability, when the substrate is heated at 140° C. for 30 minutes in the atmosphere with the ends thereof being immobilized, of 100% or less.

The separator for an electric storage device according to any one of items 1 to 3, wherein the area average major pore diameter in an ND-MD cross section of the pores included in the microporous layer (A) is 100 nm or more and 600 nm or less.

The separator for an electric storage device according to any one of items 1 to 4, wherein the microporous layer (A) constitutes each of the outermost layers on both sides of the substrate.

The separator for an electric storage device according to any one of items 1 to 5, wherein the substrate further comprises a microporous layer (C) containing 50 wt % or more of a polyolefin.

The separator for an electric storage device according to item 6, wherein the area average major pore diameter in an ND-MD cross section of the pores included in the microporous layer (C) is not less than 0.20 times and not more than 0.90 times the area average major pore diameter in an ND-MD cross section of the pores included in the microporous layer (B).

The separator for an electric storage device according to item 6 or 7, wherein the substrate comprises a structure in which the microporous layer (A), the microporous layer (B) and the microporous layer (C) are layered in the order mentioned.

The separator for an electric storage device according to any one of items 1 to 8, wherein the substrate comprises a structure in which the microporous layer (A), the microporous layer (B) and the microporous layer (A) are layered in the order mentioned.

The separator for an electric storage device according to any one of items 1 to 8, wherein, when the surface of the substrate on the side of the microporous layer (A) is defined as a first porous surface (X), and the surface thereof on the side opposite to the first porous surface (X) is defined as a second porous surface (Y), the area average major pore diameter (S_{X}) of the pores included in the first porous surface (X) is not less than 1.05 times and not more than 10 times the area average major pore diameter (S_{Y}) of the pores included in the second porous surface (Y).

The separator for an electric storage device according to item 10, wherein the average major pore diameter (S_{X}) is 80 nm or more and 600 nm or less.

The separator for an electric storage device according to any one of items 1 to 11, wherein the substrate has a heat shrinkage in the width direction, as measured after being heated at 150° C. for one hour, of−1.0% or more and 3.0% or less.

An electric storage device comprising a positive electrode, a negative electrode, and the separator for an electric storage device according to any one of items 1 to 12.

The electric storage device according to item 13, wherein the microporous layer (A) is disposed facing the negative electrode side.

The electric storage device according to item 13 or 14, wherein the positive electrode contains lithium iron phosphate as a positive electrode active material.

A separator for an electric storage device, comprising a substrate which contains 70% by weight or more of a polyolefin, and which has a first porous surface (X), and a second porous surface (Y) on the side opposite to the first porous surface (X),
wherein the area average major pore diameter (S_{X}) of the pores included in the first porous surface (X) is not less than 1.05 times and not more than 10 times the area average major pore diameter (S_{Y}) of the pores included in the second porous surface (Y).

The separator for an electric storage device according to item 16, wherein the average major pore diameter (S_{X}) is 80 nm or more and 600 nm or less.

The separator for an electric storage device according to item 16 or 17, wherein the polyolefin is polypropylene.

The separator for an electric storage device according to any one of items 16 to 18, wherein the substrate has a heat shrinkage in the width direction, as measured after being heated at 150° C. for one hour, of−1.0% or more and 3.0% or less.

An electric storage device comprising a positive electrode, a negative electrode, and the separator for an electric storage device according to any one of items 16 to 19.

The electric storage device according to item 20, wherein the first porous surface (X) is disposed facing the negative electrode side.

The electric storage device according to item 20 or 21, wherein the positive electrode contains lithium iron phosphate as a positive electrode active material.

A microporous membrane, comprising a substrate comprising:
a microporous layer (A) containing 70 wt % or more of polypropylene; and
a microporous layer (B) containing 70 wt % or more of polypropylene,
wherein the area average major pore diameter in an ND-MD cross section of the pores included in the microporous layer (B) is not more than 0.95 times the area average major pore diameter in an ND-MD cross section of the pores included in the microporous layer (A).

### Advantageous Effects of Invention

The present disclosure provides a separator for an electric storage device, which separator is capable of reducing clogging and has an excellent thermal stability, and an electric storage device using the same.

### DESCRIPTION OF EMBODIMENTS

### Separator for Electric Storage Device

The separator for an electric storage device according to the present disclosure includes a substrate including a microporous layer containing 70 wt % or more of a polyolefin. The polyolefin is preferably polypropylene. The substrate may be composed of a single (one-layer) microporous layer containing 70 wt % or more of polypropylene, or alternatively, may include a microporous layer (A) containing 70 wt % or more of polypropylene and a microporous layer (B) containing 70 wt % or more of polypropylene. The substrate may further have a coating layer (also referred to as “surface layer”, “covering layer” or the like. Hereinafter, simply referred to as “coating layer”) on one surface or both surfaces thereof. In the specification of the present application, the term “microporous layer” refers to each of the microporous layer(s) constituting the substrate of the separator, the term “substrate” refers to the substrate of the separator excluding the coating layer(s) which is/are provided arbitrarily, and the term “separator” refers to the entirety of the separator including the coating layer(s) which is/are provided arbitrarily. It is preferred that the substrate do not include a layer containing 50 wt % or more of polyethylene.

### Microporous Layer (A)

The separator for an electric storage device according to the present disclosure preferably includes a microporous layer (A) containing 70 wt % or more of polypropylene. The separator for an electric storage device may include only one microporous layer (A), or two or more microporous layers (A). At least one of the microporous layer(s) (A) constitutes the outermost layer on at least one side of the substrate. In cases where the separator for an electric storage device includes two or more microporous layers (A), the microporous layers (A) may constitute the outermost layers on both sides of the substrate. The microporous layer (A) contains 70 wt % or more of polypropylene, and this makes it possible to maintain a good battery performance after storage at a high temperature (140° C.). The lower limit of the content of polypropylene in the microporous layer (A) is 70 wt % or more, and preferably 75 wt % or more, 80 wt % or more, 85 wt % or more or 90 wt % or more, from the viewpoints of the wettability, reduction in thickness and shutdown characteristics of the separator, and the like. The upper limit of the content of polypropylene in the microporous layer (A) which can be combined with any of these lower limits is not limited, and may be, for example, 80 wt % or less, 90 wt % or less, 95 wt % or less, 98 wt % or less or 99 wt % or less, or may be 100 wt %.

### Materials of Microporous Layer (A)

The microporous layer (A) contains 70 wt % or more of polypropylene. The polypropylene contained in the microporous layer (A) may be the same material as the polypropylenes contained in the microporous layer (B) and the microporous layer (C) to be described later, or alternatively, may be a polypropylene different in chemical structure, more specifically, a polypropylene different in at least one of monomer composition, stereoregularity, molecular weight, crystal structure and the like, as compared to those in microporous layers (B) and (C).

The stereoregularity of the polypropylene is not limited, but the polypropylene may be, for example, an atactic, isotactic or syndiotactic homopolymer. The polypropylene according to the present disclosure is preferably a highly crystalline isotactic or syndiotactic homopolymer.

The polypropylene contained in the microporous layer (A) is preferably a homopolymer, or may be a copolymer in which a small amount of a comonomer other than propylene, such as an α-olefin comonomer, is copolymerized, for example, a block polymer. The amount of propylene structures contained in the polypropylene as repeating units may be, for example, 70% by mole or more, 80% by mole or more, 90% by mole or more, 95% by mole or more or 99% by mole or more, but not limited thereto. The amount of the repeating units of the comonomer may be, for example, 30% by mole or less, 20% by mole or less, 10% by mole or less, 5% by mole or less or 1% by mole or less, but not limited thereto. One kind of polypropylene can be used singly, or two or more kinds thereof can be used as a mixture.

The weight average molecular weight (Mw) of the polypropylene contained in the microporous layer (A) is preferably 300,000 or more from the viewpoint of improving the strength of the microporous layer, and the like, and preferably 1,500,000 or less from the viewpoint of increasing the pore diameter of the microporous layer and avoiding clogging. The Mw of the polypropylene is more preferably 500,000 or more and 1,300,000 or less, still more preferably 600,000 or more and 1,100,000 or less, yet still more preferably 700,000 or more and 1,050,000 or less, and particularly preferably 800,000 or more and 1,000,000 or less.

The upper limit value of the value (Mw/Mn) obtained by dividing the weight average molecular weight (Mw) of the polypropylene contained in the microporous layer (A) by the number average molecular weight (Mn) thereof, is preferably 7 or less, and more preferably 6.5 or less, 6 or less, 5.5 or less or 5 or less. The lower the value of Mw/Mn of the polypropylene is, the lower the melt tension of the resulting microporous layer (A) and the larger the pore diameter compared to the microporous layer (B) tend to be. The lower limit of the Mw/Mn which can be combined with any of these upper limits is preferably 1 or more, and may be, for example, 1.3 or more, 1.5 or more, 2.0 or more or 2.5 or more. When the Mw/Mn is 1 or more, there are cases where an appropriate molecular entanglement may be maintained and stability during film formation may be improved. It is noted that the weight average molecular weight, the number average molecular weight and the Mw/Mn of the polyolefin according to the present disclosure are molecular weights in terms of polystyrene, determined by GPC (gel permeation chromatography) measurement.

The density of the polypropylene contained in the microporous layer (A) is preferably 0.85 g/cm³ or more, and may be, for example, 0.88 g/cm³ or more, 0.89 g/cm³ or more or 0.90 g/cm³ or more. The upper limit of the density of the polypropylene which can be combined with any of these lower limits is preferably 1.1 g/cm³ or less, and may be, for example, 1.0 g/cm³ or less, 0.98 g/cm³ or less, 0.97 g/cm³ or less, 0.96 g/cm³ or less, 0.95 g/cm³ or less, 0.94 g/cm³ or less, 0.93 g/cm³ or less or 0.92 g/cm³ or less. The density of the polyolefin is related to the crystallinity of the polypropylene, and the productivity of the microporous layer is improved by adjusting the density of the polypropylene to 0.85 g/cm³ or more, making it advantageous particularly in the case of using a dry method.

The microporous layer (A) may contain another resin, as long as it contains 70 wt % or more of polypropylene. The other resin may be, for example, a polyolefin other than polypropylene (also referred to as an “other polyolefin”), or a copolymer of polystyrene and a polyolefin. A polyolefin is a polymer which contains a monomer having a carbon-carbon double bond, as a repeating unit. Examples of the monomer constituting the polyolefin other than polypropylene include, but not limited to, monomers having a carbon-carbon double bond and having 2 or 4 to 10 carbon atoms, such as ethylene, 1-butene, 4-methyl-1-pentene, 1-hexene and 1-octene. The polyolefin is, for example, a homopolymer, a copolymer, a multistage polymer or the like, and preferably a homopolymer. Specifically, the polyolefin is preferably polyethylene from the viewpoint of shutdown characteristics and the like. Preferred examples of the copolymer of polystyrene and a polyolefin include styrene-(ethylene-propylene)-styrene copolymers (SEPS), styrene-(ethylene-butene)-styrene copolymers and styrene-ethylene-styrene copolymers. A styrene-(ethylene-propylene)-styrene copolymer (SEPS) is particularly preferred.

The weight average molecular weight (Mw) of the other polyolefin is preferably 300,000 or more from the viewpoint of improving the strength of the microporous layer, and the like, and preferably 1,500,000 or less from the viewpoint of increasing the pore diameter of the microporous layer and avoiding clogging to obtain a high output. The Mw of the polyolefin is more preferably 500,000 or more and 1,300,000 or less, still more preferably 600,000 or more and 1,100,000 or less, yet still more preferably 700,000 or more and 1,000,000 or less, and particularly preferably 800,000 or more and 960,000 or less.

The upper limit value of the value (Mw/Mn) obtained by dividing the weight average molecular weight (Mw) of the other polyolefin by the number average molecular weight (Mn) thereof, is preferably 7 or less, and more preferably 6.5 or less, 6 or less, 5.5 or less or 5 or less. Further, the lower limit of the Mw/Mn of the polyolefin contained in the microporous layer (A) which can be combined with any of these upper limits is preferably 1 or more, and may be, for example, 1.3 or more, 1.5 or more, 2.0 or more or 2.5 or more. When the Mw/Mn is 1 or more, there are cases where an appropriate molecular entanglement may be maintained and stability during film formation may be improved.

### Melt Flow Rate (MFR) of Microporous Layer (A)

The upper limit value of the melt flow rate (MFR) (MFR of a single layer) of the microporous layer (A) is preferably 4.0 g/10 min or less from the viewpoint of obtaining a microporous layer (A) having a higher strength, and may be, for example, 3.0 g/10 min or less, 2.0 g/10 min or less, 1.5 g/10 min or less or 1.1 g/10 min or less. The lower limit value of the MFR (MFR of a single layer) of the microporous layer (A) which can be combined with any of these upper limits is not limited, and may be, for example, 0.3 g/10 min or more, 0.35 g/10 min or more, 0.4 g/10 min or more, 0.45 g/10 min or more or 0.5 g/10 min or more, from the viewpoint of the formability of the microporous layer (A), and the like. The MFR of the microporous layer (A) is measured under the conditions of a load of 2.16 kg and a temperature of 230° C.

The fact that the microporous layer (A) has an MFR of 4.0 g/10 min or less means that the molecular weight of the polyolefin contained in the microporous layer (A) is high to some extent. Further, the fact that the polyolefin has a high molecular weight indicates that there are a large number of tie molecules connecting crystalline materials, and this leads to a tendency that a microporous layer (A) having a high strength is obtained. When the MFR of the microporous layer (A) is 0.3 g/10 min or more, it is possible to reduce the melt tension during the formation of the microporous layer (A), and to increase the pore diameter of the microporous layer (A) compared to the pore diameter of the microporous layer (B), and thus is preferred.

The MFR of the polypropylene contained in the microporous layer (A) is preferably from 0.3 to 4.0 g/10 min when measured under the conditions of a load of 2.16 kg and a temperature of 230° C., from the viewpoint of obtaining a microporous layer (A) having a high strength. The upper limit value of the MFR of the polypropylene may be, for example, 3.0 g/10 min or less, 2.0 g/10 min or less, 1.5 g/10 min or less or 1.1 g/10 min or less, from the viewpoint of obtaining a microporous layer having a higher strength. The lower limit value of the MFR of the polypropylene which can be combined with any of these upper limits is not limited, and may be, for example, 0.3 g/10 min or more, 0.35 g/10 min or more, 0.4 g/10 min or more or 0.45 g/10 min or more, from the viewpoint of the formability of the microporous layer (A), and the like.

### Pentad Fraction of Microporous Layer (A)

The lower limit value of the pentad fraction of the polypropylene contained in the microporous layer (A) is preferably 94.0% or more from the viewpoint of obtaining a microporous layer having a low air permeability, and may be, for example, 95.0% or more, 96.0% or more, 96.5% or more, 97.0% or more, 97.5% or more, 98.0% or more, 98.5% or more or 99.0% or more. The upper limit value of the pentad fraction of the polypropylene which can be combined with any of these lower limits may be 99.9% or less, 99.8% or less or 99.5% or less, but not limited thereto. The pentad fraction of the polypropylene is measured by ¹³C-NMR (nuclear magnetic resonance method).

The fact that the pentad fraction of the polypropylene is 94.0% or more indicates that the polypropylene has a high crystallinity. In a separator obtained by the stretching pore formation process, particularly by a dry method, amorphous portions between crystalline materials are stretched to cause the formation of pores. Therefore, when the polypropylene has a high crystallinity, good pore forming properties can be obtained, and the air permeability can be reduced to a low level, as well, making it possible to achieve a high battery output.

### Area Average Major Pore Diameter of Microporous Layer (A)

The area average major pore diameter (hereinafter, also simply referred to as “area average major pore diameter”) in an ND-MD cross section of the pores included in the microporous layer (A) is preferably larger than the area average major pore diameter of the microporous layer (B). The area average major pore diameter of the microporous layer (B) is preferably not more than 0.99 times the area average major pore diameter of the microporous layer (A). In the specification of the present application, the term “ND” refers to the thickness direction of the microporous layer, and the term “MD” refers to the direction in which the microporous layer is formed. For example, if a separator including the microporous layer(s) is in the form of a roll, the MD of the separator is the longitudinal direction. The term “major pore diameter” refers to the pore diameter in the MD. Further, when the substrate includes two or more microporous layers (A) and/or microporous layers (B), the area average major pore diameters of the microporous layers (A) and the microporous layers (B) are compared based on the mean value of the area average major pore diameters of the layers of each kind.

The fact that the area average major pore diameter of the microporous layer (B) is not more than 0.99 times the area average major pore diameter of the microporous layer (A) means, namely, that the microporous layer (A) which is the outermost layer of the substrate, is a microporous layer having a larger pore diameter than that of the microporous layer (B). When the area average major pore diameter of the microporous layer (B) is not more than 0.99 times that of the microporous layer (A), it is possible to achieve both the reduction of clogging and the prevention of short circuits in a balanced manner. More specifically, it is thought that the clogging of the separator due to deposits can be reduced in battery evaluation (cycle test) when the microporous layer (A) as the outermost layer has a large pore diameter, and that the occurrence of short circuits in the resulting electric storage device can be prevented when the microporous layer (B) located in the inner layer has a small pore diameter. The area average major pore diameter of the microporous layer (B) is preferably not more than 0.95 times, and more preferably not more than 0.90 times the area average major pore diameter of the microporous layer (A). The lower limit of the area average major pore diameter of the microporous layer (B) which can be combined with any of these upper limits is preferably not less than 0.30 times, and more preferably not less than 0.40 times the area average major pore diameter of the microporous layer (A). It is thought that a sufficient strength of the separator can be ensured by adjusting the area average major pore diameter of the microporous layer (B) to not less than 0.30 times that of the microporous layer (A).

The area average major pore diameter of the microporous layer (A) is preferably 100 nm or more and 600 nm or less. When the area average major pore diameter of the microporous layer (A) is 100 nm or more, the clogging of the separator due to deposits in the electric storage device can be more effectively reduced; whereas when the area average major pore diameter thereof is 600 nm or less, the strength of the separator can further be improved. In a preferred embodiment, it is more important to reduce the clogging due to deposits in the electric storage device, and for that purpose, it is more important that the area average major pore diameter of the microporous layer (A) is 100 nm or more. The area average major pore diameter of the microporous layer (A) is more preferably 150 nm or more and 550 nm or less, still more preferably 180 nm or more and 500 nm or less, and yet still more preferably 200 nm or more and 450 nm or less.

The area average major pore diameter can be measured by observing an MD-ND cross section of the separator by cross-sectional SEM, and performing an image analysis of a region of 20 μm in the MD direction x 3 μm in the ND direction in the resulting image. Detailed conditions will be described in Examples. In the case of measuring the average pore diameter from the cross-sectional SEM image, the number average pore diameter and the area average pore diameter can be calculated. In the calculation of the number average pore diameter, however, even an extremely small pore is counted as one pore, and this makes it difficult to obtain a sufficient correlation with the physical properties of the separator. Therefore, the area average pore diameter is used as the average pore diameter in the specification of the present application so that the correlation with the physical properties of the separator can be obtained.

### Porosity of Microporous Layer (A)

The microporous layer (A) preferably has a porosity of 20% or more from the viewpoints of avoiding the clogging in the resulting electric storage device and improving the air permeability of the resulting separator, and preferably has a porosity of 70% or less from the viewpoint of maintaining the strength of the separator. The porosity of the microporous layer (A) is more preferably 25% or more and 65% or less, still more preferably 30% or more and 60% or less, and particularly preferably 35% or more and 55% or less.

### Thickness of Microporous Layer (A)

The thickness of the microporous layer (A) is preferably 10 μm or less, for example, from the viewpoint of achieving a high energy density of the resulting electric storage device, and may be, for example, 8 μm or less, 7 μm or less, 6 μm or less, 5 μm or less, 4.5 μm or less or 4 μm or less. The lower limit value of the thickness of the microporous layer (A) which can be combined with any of these upper limits is preferably 1 μm or more from the viewpoint of improving the strength, and the like, and may be, for example, 2 μm or more, 3 μm or more or 3.5 μm or more.

### Additive for Microporous Layer (A)

The microporous layer (A) containing 70 wt % or more of polypropylene may further contain, in addition to polypropylene, an additive such as an elastomer, a crystal nucleating agent, an antioxidant, a filler etc., if necessary. The amount of additive is not particularly limited, and is, for example, 0.01 wt % or more, 0.1 wt % or more or 1 wt % or more based on the total mass of the microporous layer (A). The upper limit of the amount of additive which can be combined with any of these lower limits may be 20 wt % or less, 10 wt % or less or 7 wt % or less.

### Microporous Layer (B)

The separator for an electric storage device according to the present disclosure includes a microporous layer (B). The separator for an electric storage device may include only one microporous layer (B), or two or more microporous layers (B). The microporous layer (B) contains 70 wt % or more of polypropylene, as well, and this makes it possible to maintain a good battery performance after storage at a high temperature (140° C.). The lower limit of the content of polypropylene in the microporous layer (B) may preferably be 75 wt % or more, 80 wt % or more, 85 wt % or more, 90 wt % or more or 95 wt % or more, from the viewpoints of the wettability, reduction in thickness and shutdown characteristics of the separator, and the like. The upper limit of the content of polypropylene in the microporous layer (B) which can be combined with any of these lower limits is not limited, and may be, for example, 80 wt % or less, 90 wt % or less, 95 wt % or less, 98 wt % or less or 99 wt % or less, or may be 100 wt %.

### Materials of Microporous Layer (B)

The microporous layer (B) contains 70 wt % or more of polypropylene. The polypropylene contained in the microporous layer (B) may be the same material as the polypropylenes contained in the microporous layer (A) as well as the microporous layer (C) to be described later, or alternatively, may be a polypropylene different in chemical structure, more specifically, a polypropylene different in at least one of monomer composition, stereoregularity, molecular weight, crystal structure and the like, as compared to those in microporous layers (A) and (C).

The stereoregularity of the polypropylene contained in the microporous layer (B) is not limited, but the polypropylene may be, for example, an atactic, isotactic or syndiotactic homopolymer. The polypropylene according to the present disclosure is preferably a highly crystalline isotactic or syndiotactic homopolymer.

The polypropylene contained in the microporous layer (B) is preferably a homopolymer, or may be a copolymer in which a small amount of a comonomer other than propylene, such as an α-olefin comonomer, is copolymerized, for example, a block polymer. The amount of propylene structures contained in the polypropylene as repeating units may be, for example, 70% by mole or more, 80% by mole or more, 90% by mole or more, 95% by mole or more or 99% by mole or more, but not limited thereto. The upper limit of the amount of the repeating units of the comonomer may be, for example, 30% by mole or less, 20% by mole or less, 10% by mole or less, 5% by mole or less or 1% by mole or less, but not limited thereto. One kind of polypropylene can be used singly, or two or more kinds thereof can be used as a mixture.

The weight average molecular weight (Mw) of the polypropylene contained in the microporous layer (B) is preferably 300,000 or more from the viewpoint of improving the strength of the microporous layer, and the like, and preferably 1,500,000 or less from the viewpoint of increasing the pore diameter of the microporous layer and avoiding clogging. The Mw of the polypropylene is more preferably 500,000 or more and 1,300,000 or less, still more preferably 600,000 or more and 1,100,000 or less, yet still more preferably 700,000 or more and 1,050,000 or less, and particularly preferably 800,000 or more and 1,000,000 or less.

The upper limit value of the value (Mw/Mn) obtained by dividing the weight average molecular weight (Mw) of the polypropylene contained in the microporous layer (B) by the number average molecular weight (Mn) thereof, is preferably 20 or less, and more preferably 15 or less. The lower limit value of Mw/Mn which can be combined with any of these upper limits is preferably 4 or more, and may be, for example, 4.5 or more, 5.0 or more or 5.5 or more. The higher the value of Mw/Mn of the polypropylene is, the higher the melt tension of the resulting microporous layer tends to be. Therefore, the fact that the value of Mw/Mn of the polypropylene is 4 or more means that the melt tension of the microporous layer (B) can be controlled to be higher than that of the microporous layer (A), and that as a result, the pore diameter of the microporous layer (B) can be controlled to be smaller than the pore diameter of the microporous layer (A), and thus is preferred. It is noted that the weight average molecular weight, the number average molecular weight and the Mw/Mn of the polyolefin according to the present disclosure are molecular weights in terms of polystyrene, determined by GPC (gel permeation chromatography) measurement.

The density of the polypropylene contained in the microporous layer (B) is preferably 0.85 g/cm³ or more, and may be, for example, 0.88 g/cm³ or more, 0.89 g/cm³ or more or 0.90 g/cm³ or more. The upper limit of the density of the polypropylene which can be combined with any of these lower limits is preferably 1.1 g/cm³ or less, and may be, for example, 1.0 g/cm³ or less, 0.98 g/cm³ or less, 0.97 g/cm³ or less, 0.96 g/cm³ or less, 0.95 g/cm³ or less, 0.94 g/cm³ or less, 0.93 g/cm³ or less or 0.92 g/cm³ or less. The density of the polyolefin is related to the crystallinity of the polypropylene, and the productivity of the microporous layer is improved by adjusting the density of the polypropylene to 0.85 g/cm³ or more, making it advantageous particularly in the case of using a dry method.

The microporous layer (B) may contain another resin, as long as it contains 70 wt % or more of polypropylene. The other resin may be, for example, a polyolefin other than polypropylene (also referred to as an “other polyolefin”), or a copolymer of polystyrene and a polyolefin. A polyolefin is a polymer which contains a monomer having a carbon-carbon double bond, as a repeating unit. Examples of the monomer constituting the polyolefin other than polypropylene include, but not limited to, monomers having a carbon-carbon double bond and having 2 or 4 to 10 carbon atoms, such as ethylene, 1-butene, 4-methyl-1-pentene, 1-hexene and 1-octene. The polyolefin is, for example, a homopolymer, a copolymer, a multistage polymer or the like, and preferably a homopolymer. Specifically, the polyolefin is preferably polyethylene from the viewpoint of shutdown characteristics and the like.

### Melt Flow Rate (MFR) of Microporous Layer (B)

The upper limit value of the melt flow rate (MFR) (MFR of a single layer) of the microporous layer (B) is preferably 1.5 g/10 min or less from the viewpoint of obtaining a microporous layer (B) having a higher strength, and may be, for example, 1.4 g/10 min or less, 1.3 g/10 min or less, 1.2 g/10 min or less or 1.1 g/10 min or less. The lower limit value of the MFR (MFR of a single layer) of the microporous layer (B) which can be combined with any of these upper limits is not limited, and may be, for example, 0.2 g/10 min or more, 0.25 g/10 min or more, 0.3 g/10 min or more, 0.35 g/10 min or more or 0.4 g/10 min or more, from the viewpoint of the formability of the microporous layer (B), and the like. The MFR of the microporous layer (B) is measured under the conditions of a load of 2.16 kg and a temperature of 230° C.

The fact that the microporous layer (B) has an MFR of 1.5 g/10 min or less means that the molecular weight of the polyolefin contained in the microporous layer (B) is high to some extent. Further, the fact that the polyolefin has a high molecular weight indicates that there are a large number of tie molecules connecting crystalline materials, and this leads to a tendency that a microporous layer (B) having a high strength is obtained. In addition, the melt tension can be maintained at a high level, facilitating the control to achieve a small pore diameter. When the MFR of the microporous layer (B) is 0.2 g/10 min or more, the melt tension of the microporous layer (B) can be prevented from being too low, and a microporous layer having a high strength and a reduced thickness can be more easily obtained.

The MFR of the polypropylene contained in the microporous layer (B) is preferably from 0.2 to 1.5 g/10 min when measured under the conditions of a load of 2.16 kg and a temperature of 230° C., from the viewpoint of obtaining a microporous layer (B) having a high strength. The upper limit value of the MFR of the polypropylene may be, for example, 1.4 g/10 min or less, 1.3 g/10 min or less, 1.2 g/10 min or less or 1.1 g/10 min or less, from the viewpoint of obtaining a microporous layer having a higher strength. The lower limit value of the MFR of the polypropylene which can be combined with any of these upper limits is not limited, and may be, for example, 0.25 g/10 min or more, 0.3 g/10 min or more, 0.35 g/10 min or more or 0.4 g/10 min or more, from the viewpoint of the formability of the microporous layer (B), and the like.

The MFR of the microporous layer (B) is preferably lower than the MFR of the microporous layer (A). By adjusting the MFR of the microporous layer (B) to be lower than the MFR of the microporous layer (A), the pore diameter of the microporous layer (A) of the resulting separator can be controlled to be larger than the pore diameter of the microporous layer (B) thereof. The ratio of the MFR of the microporous layer (B) and the MFR of the microporous layer (A) is preferably 0.95 or less, more preferably 0.90 or less, and still more preferably 0.85 or less. The lower limit of the above ratio which can be combined with any of these upper limits is preferably 0.2 or more, more preferably 0.3 or more, and still more preferably 0.4 or more, from the viewpoint of film-forming stability.

### Pentad Fraction of Microporous Layer (B)

The lower limit value of the pentad fraction of the polypropylene contained in the microporous layer (B) is preferably 94.0% or more from the viewpoint of obtaining a microporous layer having a low air permeability, and may be, for example, 95.0% or more, 96.0% or more, 96.5% or more, 97.0% or more, 97.5% or more, 98.0% or more, 98.5% or more or 99.0% or more. The upper limit value of the pentad fraction of the polypropylene which can be combined with any of these lower limits may be 99.9% or less, 99.8% or less or 99.5% or less, but not limited thereto. The pentad fraction of the polypropylene is measured by ¹³C-NMR (nuclear magnetic resonance method).

The fact that the pentad fraction of the polypropylene is 94.0% or more indicates that the polypropylene has a high crystallinity. In a separator obtained by the stretching pore formation process, particularly by a dry method, amorphous portions between crystalline materials are stretched to cause the formation of pores. Therefore, when the polypropylene has a high crystallinity, good pore forming properties can be obtained, and the air permeability can be reduced to a low level, as well, making it possible to achieve a high battery output.

### Area Average Major Pore Diameter of Microporous Layer (B)

The area average major pore diameter (hereinafter, also simply referred to as “area average major pore diameter”) in an ND-MD cross section of the pores included in the microporous layer (B) is smaller than the area average major pore diameter of the microporous layer (A). For details regarding the relationship with the area average major pore diameter of the microporous layer (A), see the section of <Area Average Major Pore Diameter of Microporous Layer (A)>.

The area average major pore diameter of the microporous layer (B) is preferably 40 nm or more and 500 nm or less, more preferably 60 nm or more and 450 nm or less, still more preferably 80 nm or more and 400 nm or less, and yet still more preferably 100 nm or more and 350 nm or less. When the area average major pore diameter of the microporous layer (B) is within the range described above, it is possible to more effectively reduce the clogging of the resulting separator and prevent short circuits.

### Porosity of Microporous Layer (B)

The microporous layer (B) preferably has a porosity of 20% or more from the viewpoints of avoiding the clogging in the resulting electric storage device and improving the air permeability of the resulting separator, and preferably has a porosity of 70% or less from the viewpoint of maintaining the strength of the separator. The porosity of the microporous layer (B) is more preferably 25% or more and 65% or less, still more preferably 30% or more and 60% or less, and particularly preferably 35% or more and 55% or less.

### Thickness of Microporous Layer (B)

The thickness of the microporous layer (B) according to the present disclosure is preferably 10 μm or less, for example, from the viewpoint of achieving a high energy density of the resulting electric storage device, and may be, for example, 8 μm or less, 7 μm or less, 6 μm or less, 5 μm or less, 4.5 μm or less or 4 μm or less. The lower limit value of the thickness of the microporous layer (B) which can be combined with any of these upper limits is preferably 1 μm or more from the viewpoint of improving the strength, and the like, and may be, for example, 2 μm or more, 3 μm or more or 3.5 μm or more.

### Additive for Microporous Layer (B)

The microporous layer (B) containing 70 wt % or more of polypropylene may further contain, in addition to polypropylene, an additive such as an elastomer, a crystal nucleating agent, an antioxidant, a filler etc., if necessary. The amount of additive is not particularly limited, and is, for example, 0.01 wt % or more, 0.1 wt % or more or 1 wt % or more based on the total mass of the microporous layer (B). The upper limit of the amount of additive which can be combined with any of these lower limits may be 10 wt % or less, 7 wt % or less or 5 wt % or less.

### Microporous Layer (C)

The separator for an electric storage device according to the present disclosure may further include a microporous layer (C) containing 50 wt % or more of a polyolefin, in addition to the microporous layer (A) and the microporous layer (B). In this case, the separator for an electric storage device may include only one microporous layer (C), or two or more microporous layers (C). The microporous layer (C) preferably contains 50 wt % or more of polypropylene. This makes it possible to maintain a good battery performance after storage at a high temperature (140° C.). The lower limit of the content of polypropylene in the microporous layer (C) may preferably be 55 wt % or more, 60 wt % or more, 70 wt % or more, 80 wt % or more, 90 wt % or more or 95 wt % or more, from the viewpoints of the wettability, reduction in thickness and shutdown characteristics of the separator, and the like. The upper limit of the content of polypropylene in the microporous layer (C) which can be combined with any of these lower limits is not limited, and may be, for example, 60 wt % or less, 70 wt % or less, 80 wt % or less, 90 wt % or less, 95 wt % or less, 98 wt % or less or 99 wt % or less, or may be 100 wt %.

### Materials of Microporous Layer (C)

The polypropylene contained in the microporous layer (C) may be the same material as the polypropylenes contained in the microporous layer (A) and the microporous layer (B), or alternatively, may be a polypropylene different in chemical structure, more specifically, a polypropylene different in at least one of monomer composition, stereoregularity, molecular weight, crystal structure and the like, as compared to those in microporous layers (A) and (B).

The stereoregularity of the polypropylene contained in the microporous layer (C) is not limited, but the polypropylene may be, for example, an atactic, isotactic or syndiotactic homopolymer. The polypropylene according to the present disclosure is preferably a highly crystalline isotactic or syndiotactic homopolymer.

The polypropylene contained in the microporous layer (C) is preferably a homopolymer, or may be a copolymer in which a small amount of a comonomer other than propylene, such as an α-olefin comonomer, is copolymerized, for example, a block polymer. The amount of propylene structures contained in the polypropylene as repeating units may be, for example, 70% by mole or more, 80% by mole or more, 90% by mole or more, 95% by mole or more or 99% by mole or more, but not limited thereto. The upper limit of the amount of the repeating units of the comonomer may be, for example, 30% by mole or less, 20% by mole or less, 10% by mole or less, 5% by mole or less or 1% by mole or less, but not limited thereto. One kind of polypropylene can be used singly, or two or more kinds thereof can be used as a mixture.

The weight average molecular weight (Mw) of the polypropylene contained in the microporous layer (C) is preferably 300,000 or more from the viewpoint of improving the strength of the microporous layer, and the like, and preferably 1,500,000 or less from the viewpoint of increasing the pore diameter of the microporous layer and avoiding clogging. The Mw of the polypropylene is more preferably 500,000 or more and 1,300,000 or less, still more preferably 600,000 or more and 1,100,000 or less, yet still more preferably 700,000 or more and 1,050,000 or less, and particularly preferably 800,000 or more and 1,000,000 or less.

The upper limit value of the value (Mw/Mn) obtained by dividing the weight average molecular weight (Mw) of the polypropylene contained in the microporous layer (C) by the number average molecular weight (Mn) thereof, is preferably 20 or less, and more preferably 15 or less. The lower limit value of Mw/Mn which can be combined with any of these upper limits is preferably 4 or more, and may be, for example, 4.5 or more, 5.0 or more or 5.5 or more. The higher the value of Mw/Mn of the polypropylene is, the higher the melt tension of the resulting microporous layer tends to be. Therefore, the fact that the value of Mw/Mn of the polypropylene is 4 or more means that the melt tension of the microporous layer (C) can be controlled to be higher than that of the microporous layer (B), and that as result, the pore diameter of the microporous layer (C) can be controlled to be smaller than the pore diameter of the microporous layer (B), and thus is preferred. It is noted that the weight average molecular weight, the number average molecular weight and the Mw/Mn of the polyolefin according to the present disclosure are molecular weights in terms of polystyrene, determined by GPC (gel permeation chromatography) measurement.

The density of the polypropylene contained in the microporous layer (C) is preferably 0.85 g/cm³ or more, and may be, for example, 0.88 g/cm³ or more, 0.89 g/cm³ or more or 0.90 g/cm³ or more. The upper limit of the density of the polypropylene which can be combined with any of these lower limits is preferably 1.1 g/cm³ or less, and may be, for example, 1.0 g/cm³ or less, 0.98 g/cm³ or less, 0.97 g/cm³ or less, 0.96 g/cm³ or less, 0.95 g/cm³ or less, 0.94 g/cm³ or less, 0.93 g/cm³ or less or 0.92 g/cm³ or less. The density of the polyolefin is related to the crystallinity of the polypropylene, and the productivity of the microporous layer is improved by adjusting the density of the polypropylene to 0.85 g/cm³ or more, making it advantageous particularly in the case of using a dry method.

The microporous layer (C) may contain another resin, in addition to polypropylene. The other resin may be, for example, a polyolefin other than polypropylene (also referred to as an “other polyolefin”), or a copolymer of polystyrene and a polyolefin. A polyolefin is a polymer which contains a monomer having a carbon-carbon double bond, as a repeating unit. Examples of the monomer constituting the polyolefin other than polypropylene include, but not limited to, monomers having a carbon-carbon double bond and having 2 or 4 to 10 carbon atoms, such as ethylene, 1-butene, 4-methyl-1-pentene, 1-hexene and 1-octene. The polyolefin is, for example, a homopolymer, a copolymer, a multistage polymer or the like, and preferably a homopolymer. Specifically, the polyolefin is preferably polyethylene from the viewpoint of shutdown characteristics and the like.

### Melt Flow Rate (MFR) of Microporous Layer (C)

The upper limit value of the melt flow rate (MFR) (MFR of a single layer) of the microporous layer (C) is preferably 1.5 g/10 min or less from the viewpoint of obtaining a microporous layer (C) having a higher strength, and may be, for example, 1.4 g/10 min or less, 1.3 g/10 min or less, 1.2 g/10 min or less or 1.1 g/10 min or less. The lower limit value of the MFR (MFR of a single layer) of the microporous layer (C) which can be combined with any of these upper limits is not limited, and may be, for example, 0.2 g/10 min or more, 0.25 g/10 min or more, 0.3 g/10 min or more, 0.35 g/10 min or more or 0.4 g/10 min or more, from the viewpoint of the formability of the microporous layer (C), and the like. The MFR of the microporous layer (C) is measured under the conditions of a load of 2.16 kg and a temperature of 230° C.

The fact that the microporous layer (C) has an MFR of 1.5 g/10 min or less means that the molecular weight of the polyolefin contained in the microporous layer (C) is high to some extent. Further, the fact that the polyolefin has a high molecular weight indicates that there are a large number of tie molecules connecting crystalline materials, and this leads to a tendency that a microporous layer (C) having a high strength is obtained. When the MFR of the microporous layer (C) is 0.2 g/10 min or more, the melt tension of the microporous layer (C) can be prevented from being too low, and a microporous layer having a high strength and a reduced thickness can be more easily obtained.

The MFR of the polypropylene contained in the microporous layer (C) is preferably from 0.2 to 1.5 g/10 min when measured under the conditions of a load of 2.16 kg and a temperature of 230° C., from the viewpoint of obtaining a microporous layer (C) having a high strength. The upper limit value of the MFR of the polypropylene may be, for example, 1.4 g/10 min or less, 1.3 g/10 min or less, 1.2 g/10 min or less or 1.1 g/10 min or less, from the viewpoint of obtaining a microporous layer having a higher strength. The lower limit value of the MFR of the polypropylene which can be combined with any of these upper limits is not limited, and may be, for example, 0.25 g/10 min or more, 0.3 g/10 min or more, 0.35 g/10 min or more or 0.4 g/10 min or more, from the viewpoint of the formability of the microporous layer (C), and the like.

### Pentad Fraction of Microporous Layer (C)

The lower limit value of the pentad fraction of the polypropylene contained in the microporous layer (C) is preferably 94.0% or more from the viewpoint of obtaining a microporous layer having a low air permeability, and may be, for example, 95.0% or more, 96.0% or more, 96.5% or more, 97.0% or more, 97.5% or more, 98.0% or more, 98.5% or more or 99.0% or more. The upper limit value of the pentad fraction of the polypropylene which can be combined with any of these lower limits may be 99.9% or less, 99.8% or less or 99.5% or less, but not limited thereto. The pentad fraction of the polypropylene is measured by ¹³C-NMR (nuclear magnetic resonance method).

The fact that the pentad fraction of the polypropylene is 94.0% or more indicates that the polypropylene has a high crystallinity. In a separator obtained by the stretching pore formation process, particularly by a dry method, amorphous portions between crystalline materials are stretched to cause the formation of pores. Therefore, when the polypropylene has a high crystallinity, good pore forming properties can be obtained, and the air permeability can be reduced to a low level, as well, making it possible to achieve a high battery output.

### Area Average Major Pore Diameter of Microporous Layer (C)

The area average major pore diameter (hereinafter, also simply referred to as “area average major pore diameter”) in an ND-MD cross section of the pores included in the microporous layer (C) is preferably smaller than the area average major pore diameter of the microporous layer (B). Specifically, the area average major pore diameter of the microporous layer (C) is preferably not less than 0.20 times and not more than 0.90 times, and more preferably not less than 0.50 times and not more than 0.90 times the area average major pore diameter of the microporous layer (B). This makes it possible to more effectively reduce the clogging of the resulting separator and prevent short circuits. When the substrate includes two or more microporous layers (C) and/or microporous layers (B), the area average major pore diameters of the microporous layers (C) and the microporous layers (B) are compared based on the mean value of the area average major pore diameters of the layers of each kind.

The area average major pore diameter of the microporous layer (C) is preferably 20 nm or more and 450 nm or less, more preferably 40 nm or more and 400 nm or less, still more preferably 60 nm or more and 350 nm or less, and yet still more preferably 80 nm or more and 300 nm or less. When the area average major pore diameter of the microporous layer (C) is within the range described above, it is possible to more effectively reduce the clogging of the separator and prevent short circuits.

### Porosity of Microporous Layer (C)

The microporous layer (C) preferably has a porosity of 20% or more from the viewpoints of avoiding the clogging in the resulting electric storage device and improving the air permeability of the resulting separator, and preferably has a porosity of 70% or less from the viewpoint of maintaining the strength of the separator. The porosity of the microporous layer (C) is more preferably 25% or more and 65% or less, still more preferably 30% or more and 60% or less, and particularly preferably 35% or more and 55% or less.

### Thickness of Microporous Layer (C)

The thickness of the microporous layer (C) according to the present disclosure is preferably 10 μm or less, for example, from the viewpoint of achieving a high energy density of the resulting electric storage device, and may be, for example, 8 μm or less, 7 μm or less, 6 μm or less, 5 μm or less, 4.5 μm or less or 4 μm or less. The lower limit value of the thickness of the microporous layer (C) which can be combined with any of these upper limits is preferably 1 μm or more from the viewpoint of improving the strength, and the like, and may be, for example, 2 lam or more, 3 μm or more or 3.5 μm or more.

### Additive for Microporous Layer (C)

The microporous layer (C) may further contain, in addition to polypropylene, an additive such as an elastomer, a crystal nucleating agent, an antioxidant, a filler etc., if necessary. The amount of additive is not particularly limited, and is, for example, 0.01 wt % or more, 0.1 wt % or more or 1 wt % or more based on the total mass of the microporous layer (C). The upper limit of the amount of additive which can be combined with any of these lower limits may be 10 wt % or less, 7 wt % or less or 5 wt % or less.

### Area Average Major Pore Diameter of Substrate Surface

The substrate preferably contains a polyolefin as a main component, and has a first porous surface (X), and a second porous surface (Y) on the side opposite to the first porous surface (X). The area average major pore diameter (S_{X}) of the pores included in the first porous surface (X) is preferably not less than 1.05 times and not more than 10 times, more preferably not less than and 1.1 times and not more than 5 times, and still more preferably not less than 1.2 times and not more than 3 times the area average major pore diameter (S_{Y}) of the pores included in the second porous surface (Y). The surface (X) and the surface (Y) may be constituted by the surfaces of a single (one-layer) microporous layer; or alternatively, the surface (X) may be constituted by the surface of one microporous layer, of layered microporous layers in which two or more layers are layered, and the surface (Y) may be constituted by the surface of another microporous layer, of the layered microporous layers. When the substrate has a layered structure including at least one each of the microporous layer (A) and the microporous layer (B), the surface on the side of the microporous layer (A) corresponds to the first porous surface (X), and the surface of the microporous membrane on the side opposite to the microporous layer (A) corresponds to the second porous surface (Y).

The area average major pore diameter of each surface can be measured by observing the surface of the separator by SEM, and performing an image analysis of the resulting image. The term “major pore diameter” refers to the pore diameter in the MD. The term “MD” refers to the direction in which the microporous layer is formed. For example, if a separator including the microporous layer(s) is in the form of a roll, the MD of the separator is the longitudinal direction. In the case of measuring the average pore diameter from the surface SEM image, the number average pore diameter and the area average pore diameter can be calculated. In the calculation of the number average pore diameter, however, even an extremely small pore is counted as one pore, and this makes it difficult to obtain a sufficient correlation with the physical properties of the separator. Therefore, the area average pore diameter is used as the average pore diameter in the specification of the present application so that the correlation with the physical properties of the separator can be obtained.

The fact that the area average major pore diameter (S_{X}) of the surface (X) is not less than 1.05 times the area average major pore diameter (S_{Y}) of the surface (Y) means that the surface (X) has a larger pore diameter than that of the surface (Y). When the area average major pore diameter (S_{X}) of the surface (X) is not less than 1.05 times the area average major pore diameter (S_{Y}) of the surface (Y), the clogging of the substrate in battery evaluation (cycle test) can be reduced, and the occurrence of short circuits due to mixing of foreign substances can be prevented. When the area average major pore diameter (S_{X}) of the surface (X) is not more than 10 times the area average major pore diameter (S_{Y}) of the surface (Y), it is thought that the strength of the separator can be sufficiently ensured.

The area average major pore diameter (S_{X}) of the surface (X) is preferably 80 nm or more and 600 nm or less, more preferably 120 nm or more and 550 nm or less, still more preferably 130 nm or more and 500 nm or less, and yet still more preferably 140 nm or more and 450 nm or less. The clogging of the separator due to deposits in the electric storage device can be more effectively reduced when the area average major pore diameter of the surface (X) is 80 nm or more, and the strength of the separator can further be improved when the area average major pore diameter is 600 nm or less. It is preferred to reduce the clogging due to deposits in the electric storage device, and for that purpose, the area average major pore diameter of the surface (X) is preferably 80 nm or more.

The area average major pore diameter (S_{Y}) of the surface (Y) is preferably 20 nm or more and 500 nm or less, more preferably 30 nm or more and 450 nm or less, and still more preferably 40 nm or more and 400 nm or less, and yet still more preferably 50 nm or more and 350 nm or less. When the area average major pore diameter of the microporous layer (B) is within the range described above, it is possible to more effectively reduce the clogging of the separator and prevent short circuits.

### Layer Structure of Substrate

The substrate (also simply referred to as “substrate” in the specification of the present application) of the separator for an electric storage device is composed of a single (one-layer) microporous layer, or includes at least one each of the microporous layer (A) and the microporous layer (B). The substrate may have a multilayer structure of three or more layers including two or more microporous layers (A) and/or microporous layers (B). Examples of the multilayer structure include a two-layer structure of the microporous layer (A)/the microporous layer (B), and a three-layer structure of the microporous layer (A)/the microporous layer (B)/the microporous layer (A). Further, the substrate may include a layer other than the microporous layer (A) and the microporous layer (B). Examples of the layer other than the microporous layer (A) and the microporous layer (B) include the microporous layer (C) described above, a layer containing an inorganic substance and a layer containing a heat-resistant resin. For example, the substrate may have a multilayer structure of four or more layers, such as a structure of the microporous layer (A)/the microporous layer (B)/the microporous layer (C)/the microporous layer (A). A symmetrically layered structure is preferred from the viewpoints of the ease of production, the prevention of curling of the separator, and the like.

In cases where the substrate includes the microporous layer (C), the substrate preferably has a three-layer structure of the microporous layer (A)/the microporous layer (B)/the microporous layer (C). When the substrate has such a layered structure, it is possible to more effectively reduce the clogging of the separator and prevent short circuits.

### Thickness of Substrate

The upper limit value of the thickness of the substrate is preferably 25 μm or less, for example, from the viewpoint of achieving a high energy density of the resulting electric storage device, and may be, for example, 22 μm or less, 20 μm or less, 18 μm or less, 16 μm or less, 14 lam or less or 12 μm or less. The lower limit value of the thickness of the substrate which can be combined with any of these upper limits is preferably 6 μm or more from the viewpoint of improving the strength, and the like, and may be, for example, 7 μm or more, 8 μm or more, 9 lam or more or 10 μm or more.

### Air Permeability (Air Resistance) of Substrate

The upper limit value of the air permeability of the substrate is preferably 290 sec/100 cm³ or less when the thickness of the substrate is converted to 16 μm, and may be, for example, 280 sec/100 cm³ or less, 270 sec/100 cm³ or less, 260 sec/100 cm³ or less or 250 sec/100 cm³ or less. The lower limit value of the air permeability of the substrate which can be combined with any of these upper limits is not limited, and may be, for example, 50 sec/100 cm³ or more, 60 sec/100 cm³ or more or 70 sec/100 cm³ or more, when the thickness of the substrate is converted to 16 μm.

Air Permeability (Air Resistance) after High Temperature Treatment of Substrate

The substrate according to the present disclosure preferably has a rate of change in air permeability, after the substrate is heated at 140° C. for 30 minutes in the atmosphere (hereinafter, also simply referred to as “after high temperature treatment”) with the ends thereof being immobilized, of 100% or less. The rate of change in air permeability can be determined by the following equation:

Rate of change in air permeability (%)={air permeability (sec/100 cm³) after heating—air permeability (sec/100 cm³) before heating}÷ air permeability (sec/100 cm³) after heating x 100 The expression “with the ends thereof being immobilized” refers to subjecting the substrate to a heat treatment in a state where the ends of the substrate are fixed, supposing a situation where the separator is fixed in the production of an electric storage device.

In the case of a conventional separator which includes a substrate including a layer containing polyethylene as a main component, there are cases where the air permeability after high temperature treatment exceeds 5,000 sec/100 cm³. In contrast, the fact that the rate of change in air permeability is 100% or less means that the change in air permeability is extremely small even after being exposed to a high temperature due to a drying treatment and the like. When the rate of change in air permeability is 100% or less, it is possible to ensure a good battery performance after high temperature drying in the production of an electric storage device. The rate of change in air permeability is preferably 80% or less, 60% or less, 40% or less, 20% or less, 10% or less or 5% or less, and the lower limit which can be combined with any of these upper limits is preferably−5% or more,−3% or more,−2% or more,−1% or more, 0% or more, or more than 0%, but not limited thereto.

The upper limit value of the air permeability after high temperature treatment of the substrate according to the present disclosure is preferably 580 sec/100 cm³ or less when the thickness of the substrate is converted to 16 μm, and may be, for example, 500 sec/100 cm³ or less, 450 sec/100 cm³ or less, 400 sec/100 cm³ or less or 350 sec/100 cm³ or less. The lower limit value of the air permeability after high temperature treatment of the substrate which can be combined with any of these upper limits is not limited, and may be, for example, 50 sec/100 cm³ or more, 60 sec/100 cm³ or more or 70 sec/100 cm³ or more, when the thickness of the substrate is converted to 16 μm.

### Porosity of Substrate

The substrate preferably has a porosity of 20% or more from the viewpoints of avoiding the clogging in the resulting electric storage device and improving the air permeability of the resulting separator, and preferably has a porosity of 70% or less from the viewpoint of maintaining the strength of the separator. The porosity of the substrate is more preferably 25% or more and 65% or less, still more preferably 30% or more and 60% or less, and particularly preferably 35% or more and 55% or less.

### Puncture Strength of Substrate

The lower limit value of the puncture strength of the substrate is preferably 230 gf or more, 240 gf or more, 250 gf or more, 260 gf or more, 280 gf or more, 300 gf or more or 320 gf or more, when the thickness of the substrate is converted to 16 μm. The upper limit value of the puncture strength of the substrate which can be combined with any of these lower limits is not limited, and is preferably 550 gf or less when the thickness of the substrate is converted to 16 μm, and may be, for example, 500 gf or less or 480 gf or less.

### Heat Shrinkage of Substrate

The substrate preferably has a heat shrinkage in the width direction (TD), as measured after being heat-treated at 150° C. for one hour, of−1.0% or more and 3.0% or less. That is, the fact that the above-described heat shrinkage is within the range described above means that the substrate has an extremely low heat shrinkage in the width direction, even at a high temperature. When the above-described heat shrinkage is 3.0% or less, the occurrence of short circuits at a high temperature can be effectively prevented. The reason that the above-described heat shrinkage is−1.0% or more is because there are cases where the substrate is slightly expanded in the width direction at the time of measuring the heat shrinkage, resulting in a heat shrinkage of less than 0%, namely, a negative value. The above-described heat shrinkage may be 0% or more, or may be more than 0%. A substrate in which the above-described heat shrinkage is−1.0% or more and 3.0% or less can be produced, for example, by a method such as dry uniaxial stretching. In general, a wet separator has an extremely high heat shrinkage in the width direction. In the case of a uniaxially stretched dry separator, in contrast, a substrate in which the above-described heat shrinkage is−1.0% or more and 3.0% or less can be more easily obtained, regardless of the pore diameter ratio of the inner and outer layers.

Method of Producing Separator for Electric storage device

A method of producing a separator for an electric storage device includes: a melt extrusion step of melt extruding a resin composition (hereinafter, also referred to as “polypropylene-based resin composition”) containing polypropylene as a main component to obtain a resin film; and a pore formation step of forming pores in the resulting resin film to make the film porous. Methods of producing a microporous layer can be broadly classified into dry methods in which no solvent is used in the pore formation step, and wet methods in which a solvent is used in the pore formation step.

Examples of the dry method include: a method in which a polypropylene-based resin composition is melt-blended and extruded, and then the extrudate is subjected to a heat treatment and stretching to cause delamination at the interfaces between polypropylene crystals; and a method in which a polypropylene-based resin composition and an inorganic filler are melt-blended to be formed into a film, and then the film is stretched to cause delamination at the interfaces between polypropylene and the inorganic filler.

Examples of the wet method include: a method in which a polypropylene-based resin composition and a pore-forming material are melt-blended to be formed into a film, the film is stretched as necessary, and then the pore-forming material is extracted; and a method in which a polypropylene-based resin composition is melted, and then immersed in a poor solvent for polypropylene to solidify the polypropylene and to remove the solvent simultaneously.

A single-screw extruder and a twin screw extruder can be used for the melt blending of the polypropylene-based resin composition. In addition to these extruders, it is also possible to use, for example, a kneader, a Labo Plasto mill, a mixing roll, a Banbury mixer and the like.

The polypropylene-based resin composition may optionally contain a resin other than polypropylene, an additive and the like, depending on the method of producing a microporous layer, or depending on the physical properties of the microporous layer of interest. Examples of the additive include a pore-forming material, a fluorine-based flow modifier, a wax, a crystal nucleating agent, an antioxidant, a metallic soap such as an aliphatic metal carboxylate, an ultraviolet absorber, a photostabilizer, an antistatic agent, an antifogging agent and a color pigment. Examples of the pore-forming material include a plasticizer, an inorganic filler and a combination thereof.

Examples of the plasticizer include: hydrocarbons such as liquid paraffin and paraffin wax; esters such as dioctyl phthalate and dibutyl phthalate; and higher alcohols such as oleyl alcohol and stearyl alcohol.

Examples of the inorganic filler include: oxide-based ceramics such as alumina, silica (silicon oxide), titania, zirconia, magnesia, ceria, yttria, zinc oxide and iron oxide; nitride-based ceramics such as silicon nitride, titanium nitride and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth and silica sand; and glass fibers.

A lamella crystal pore formation process by a dry method, in which a heat treatment and stretching are carried out to cause delamination at the interfaces between polypropylene crystals, is preferred as a method of producing a substrate. As a method of producing a substrate including the microporous layer (A) and the microporous layer (B), it is preferred to use at least one of the following processes (i) and (ii):
(i) a process of producing a substrate by co-extrusion film formation, in which the microporous layer (A) and the microporous layer (B) are formed by co-extruding the respective resin compositions, and subjecting the co-extruded film to annealing, cold stretching, hot stretching and heat relaxation steps; and
(ii) a process of producing a substrate by lamination, in which the microporous layer (A) and the microporous layer (B) are formed by separately extruding the respective resin compositions, laminating and pasting the extruded films with each other, and then subjecting the resulting laminate to annealing, cold stretching, hot stretching and heat relaxation steps.

Likewise, in the case of a substrate further including the microporous layer (C), as well, examples of the production method thereof include the following processes:
(i) a process of producing a substrate by co-extrusion film formation, in which the microporous layer (A), the microporous layer (B) and the microporous layer (C) are formed by co-extruding the respective resin compositions, and subjecting the co-extruded film to annealing, cold stretching, hot stretching and heat relaxation steps; and
(ii) a process of producing a substrate by lamination, in which the microporous layer (A), the microporous layer (B) and the microporous layer (C) are formed by extruding at least one of the resin compositions separately from others, laminating and pasting the extruded films with each other, and then subjecting the resulting laminate to annealing, cold stretching, hot stretching and heat relaxation steps.

The absolute values of the area average major pore diameters in a ND-MD cross section of the microporous layer (A) and the microporous layer (B) as well as of the microporous layer (C) optionally included, and the ratios thereof, can be adjusted to the preferred ranges of the present disclosure, for example, by a method of changing the molecular weight of the polypropylene contained in each layer, a method of adding an additive, etc. The present inventors have found out that it is possible to control the pore diameter of one microporous layer to be smaller than that of another layer, by using, in said one microporous layer, a polypropylene having a molecular weight higher than that of the polypropylene used in said another layer. The present inventors have also found that it is possible to control the pore diameter of one microporous layer to be larger than that of another layer, by adding an additive having a specific structure, typified by a styrene-olefin copolymer, to said one microporous layer. Further, the present inventors have found that it is possible to obtain a good battery performance and heat resistance as well as to prevent short circuits at the same time, by strictly controlling the pore diameter of each layer.

When the substrate has a layered structure composed of two or more layers, the absolute values of the area average major pore diameter (S_{X}) of the surface (X) and the area average major pore diameter (S_{Y}) of the surface (Y), and the ratio thereof, can be adjusted to the preferred ranges of the present disclosure, for example, by a method of changing the molecular weight of the polypropylene contained in each layer having each surface, a method of adding an additive, etc. It is possible to control the pore diameter of one microporous layer having the surface on one side to be smaller than that of another layer having the surface on the other side, by using, in said one microporous layer, a polypropylene having a molecular weight higher than that of the polypropylene used in said another layer. Further, it is possible to control the pore diameter of one microporous layer having the surface on one side to be larger than that of another layer having the surface on the other side, by adding an additive having a specific structure, typified by a styrene-olefin copolymer, to said one microporous layer. Further, the present inventors have found that it is possible to obtain a good battery performance and heat resistance as well as to prevent short circuits at the same time, by strictly controlling the pore diameter of each layer.

When the substrate is composed of a single (one-layer) microporous layer, the absolute values of the area average major pore diameter (S_{X}) of the surface (X) and the area average major pore diameter (S_{Y}) of the surface (Y), and the ratio thereof, can be adjusted to the preferred ranges of the present disclosure, for example, by a method of forming a gradient in the molecular weight within the single layer during film formation, a method of allowing a larger amount of additive to be contained on one side of the layer, etc. Such a method enables to control the pore diameter of the surface on the side having a lower molecular weight or containing a larger amount of additive to be larger than that on the other side.

A multilayer separator composed of a layer containing polypropylene as a main component and having a small pore diameter, and a layer containing polyethylene and having a large pore diameter, has been conventionally known. Without being limited to a theory, the pore diameter of the polyethylene-containing layer can be controlled to be larger than that of the layer containing polypropylene as a main component, by using a polyethylene which is highly crystalline and which has a crystal size larger than that of polypropylene. However, when the substrate includes a layer containing polyethylene as a main component, there has been a problem that a heat treatment at a high temperature equal to or higher than the melting point (128° C.) of polyethylene causes the clogging of the pores, resulting in a failure to function as a separator. On the other hand, in a substrate having a multilayer structure which does not include a layer containing polyethylene as a main component, and which is composed of layers containing polypropylene as a main component, it has been extremely difficult to independently control the pore diameters of the respective layers, and to form a multilayer structure in which the pore diameters of the respective are different.

Of the co-extrusion process (i) and the lamination process (ii), the co-extrusion process (i) is preferred from the viewpoint of production cost and the like. In the co-extrusion process (i), it is preferred to extrude the resins at a temperature as low as possible, and to effectively perform rapid cooling of the co-extruded film by blowing a low temperature air thereto, as extrusion film formation conditions for the microporous layers (A) to (C). After the film formation, it is preferred to rapidly cool the co-extruded film by blowing air, and the temperature of the blowing air is preferably 20° C. or lower, and more preferably 15° C. or lower. By blowing cold air controlled to such a low temperature, the resins after the film formation are uniformly oriented in the MD direction while being rapidly cooled.

The method of producing a substrate may include an annealing step, after the extrusion film formation. Performing the annealing step tends to allow the crystal structures of the microporous layers (A) to (C) to grow, and to improve the pore forming properties. There is a tendency that a good area average major pore diameter can be obtained in all of the microporous layers (A) to (C), by performing the annealing step at a specific temperature for long hours. The reason for this is thought to be because crystals can grow without crystal structure disturbances, enabling to obtain high pore forming properties. Further, there is a tendency that a good area average major pore diameter can be obtained in both of the microporous layers (A) and (B), by performing the annealing step at a specific temperature for long hours. The reason for this is thought to be because crystals can grow without crystal structure disturbances, enabling to obtain high pore forming properties. In the annealing step, it is preferred to perform an annealing treatment preferably within the temperature range of 115° C. or higher and 160° C. or lower, for preferably 20 minutes or more, more preferably for 60 minutes or more, from the viewpoints of obtaining a good area average major pore diameter, and obtaining a good area average major pore diameter to prevent the clogging of the resulting electric storage device.

After the annealing step, the method of producing a substrate may include a stretching step, during the pore formation step or before or after the pore formation step. Any of uniaxial stretching and biaxial stretching methods can be used for a stretching treatment. Although not limited thereto, uniaxial stretching is preferred, for example, from the viewpoint of production cost in the case of using a dry method. Biaxial stretching is preferred, for example, from the viewpoint of improving the strength of the resulting substrate. Examples of the biaxial stretching include methods such as simultaneous biaxial stretching, sequential biaxial stretching, multistage stretching and multiple-time stretching. Simultaneous biaxial stretching is preferred from the viewpoints of a puncture strength improvement, stretching uniformity and shutdown characteristics. Further, sequential biaxial stretching is preferred from the viewpoint of the ease of control of the plane orientation. When a molded product in the form of a sheet is stretched in biaxial directions at high magnifications, molecules are oriented in the plane direction, and a substrate which is less susceptible to tearing and which has a high puncture strength tends to be obtained.

In order to reduce the heat shrinkage of the substrate, a heat treatment step may be carried out for the purpose of performing heat setting, after the stretching step or after the pore formation step. The heat treatment step may include: a stretching operation which is carried out at a predetermined temperature atmosphere and a predetermined stretching ratio, for the purpose of adjusting the physical properties; and/or a relaxation operation which is carried out at a predetermined temperature atmosphere and a predetermined relaxation rate, for the purpose of reducing the stretching stress. The relaxation operation may be carried out after performing the stretching operation. Such a heat treatment step can be carried out using a tenter or a roll stretching machine.

The resulting substrate itself can be used as it is as a separator for an electric storage device. Optionally, a coating layer may further be provided on one surface or both surfaces of the substrate.

Electric storage device

The electric storage device according to the present disclosure includes the separator for an electric storage device according to the present disclosure. The electric storage device according to the present disclosure includes a positive electrode and a negative electrode, and the separator for an electric storage device is preferably layered between the positive electrode and the negative electrode. The microporous layer (A) constituting the outermost layer of the substrate is preferably disposed facing the negative electrode side. Since the clogging of the separator in the electric storage device is mostly due to deposits on the surface of the negative electrode, the clogging of the separator can be effectively reduced by disposing the microporous layer (A) having a relatively large pore diameter so as to face the negative electrode side. The surface (X) of the substrate is preferably disposed facing the negative electrode side. Since the clogging of the separator in the electric storage device is mostly due to deposits on the surface of the negative electrode, the clogging of the separator can be effectively reduced by disposing the surface (X) having a relatively large pore diameter so as to face the negative electrode side.

Examples of the electric storage device include, but not limited to, lithium secondary batteries, lithium-ion secondary batteries, sodium secondary batteries, sodium-ion secondary batteries, magnesium secondary batteries, magnesium-ion secondary batteries, calcium secondary batteries, calcium-ion secondary batteries, aluminum secondary batteries, aluminum-ion secondary batteries, nickel-hydrogen batteries, nickel-cadmium batteries, electric double layer capacitors, lithium-ion capacitors, redox flow batteries, lithium-sulfur batteries, lithium-air batteries, and zinc-air batteries. Among these, a lithium secondary battery, a lithium-ion secondary battery, a nickel-hydrogen battery or a lithium-ion capacitor is preferred, and a lithium-ion secondary battery is more preferred, from the viewpoint of practical use.

The electric storage device can be produced, for example, by: layering a positive electrode and a negative electrode, with the separator described above interposed therebetween; winding the resulting layered member, as necessary, to form a layered electrode member or a wound electrode member; then housing the layered electrode member or the wound electrode member in an exterior; connecting the positive and negative electrodes with positive and negative electrode terminals of the exterior via leads or the like; further, injecting a nonaqueous electrolytic solution containing a nonaqueous solvent such as an acyclic or cyclic carbonate and an electrolyte such as a lithium salt, into the exterior; and then sealing the exterior.

The electric storage device is more preferably a lithium-ion secondary battery. Preferred embodiments of a lithium-ion secondary battery will now be described. However, the electric storage device according to the present disclosure is not limited to a lithium-ion secondary battery.

The positive electrode is not particularly limited as long as it functions as a positive electrode of a lithium-ion secondary battery, and a known one can be used. The positive electrode preferably contains, as a positive electrode active material(s), one or more materials selected from the group consisting of materials capable of occluding and releasing lithium ions. From the viewpoint of battery capacity and safety, preferred examples of the positive electrode include: lithium cobalt oxides typified by LiCoO₂; spinel-based lithium manganese oxides typified by Li₂Mn₂O₄; spinel-based lithium nickel manganese oxides typified by Li₂Mn_{1.5}Ni_{0.5}O₄; lithium nickel oxides typified by LiNiO₂; lithium-containing composite metal oxides represented by LiMO₂ (wherein M represents two or more elements selected from the group consisting of Ni, Mn, Co, AI and Mg); and lithium iron phosphate compounds represented by LiFePO₄. Among these, from the viewpoint of high safety and long-term stability, more preferred are: lithium cobalt oxides typified by LiCoO₂; lithium nickel oxides typified by LiNiO₂; lithium-containing composite metal oxides represented by LiMO₂ (wherein M represents two or more elements selected from the group consisting of Ni, Mn, Co, AI and Mg); and lithium iron phosphate compounds represented by LiFePO₄, and particularly preferred are lithium iron phosphate compounds represented by LiFePO₄.

The negative electrode is not particularly limited as long as it functions as a negative electrode of a lithium-ion secondary battery, and may be a known one. The negative electrode preferably contains, as a negative electrode active material(s), one or more materials selected from the group consisting of lithium metal and materials capable of occluding and releasing lithium ions. That is, the negative electrode preferably contains, as a negative electrode active material(s), one or more materials selected from the group consisting of lithium metal, a carbon material, a material containing an element capable of forming an alloy with lithium and a lithium-containing compound. Examples of such a material include, in addition to lithium metal, carbon materials typified by hard carbon, soft carbon, artificial graphite, natural graphite, graphite, pyrolytic carbon, coke, glassy carbon, calcined products of organic polymer compounds, meso-carbon microbeads, carbon fibers, activated carbon, graphite, carbon colloid and carbon black.

### EXAMPLES

### Measurement and Evaluation Methods

### [Measurement of Melt Flow Rate (MFR)]

The melt flow rate (MFR) (unit: g/10 min) of each microporous layer was measured under the conditions of a temperature of 230° C. and a load of 2.16 kg, in accordance with JIS K 7210. The MFR of polypropylene was measured under the conditions of a temperature of 230° C. and a load of 2.16 kg, in accordance with JIS K 7210. However, the melt flow rate (MFR) of polyethylene and the melt flow rate (MFR) of a microporous layer containing 50 wt % or more of polyethylene were measured under the conditions of a temperature of 190° C. and a load 2.16 kg, in accordance with JIS K 7210.

[Measurement of Mw and Mn by GPC (gel permeation chromatography)]

Using Agilent PL-GPC220, standard polystyrene was measured under the following conditions to prepare a calibration curve. Each sample polymer was also measured by chromatography under the same conditions, and the weight average molecular weight (Mw) in terms of polystyrene, the number average molecular weight (Mn), and the value (Mw/Mn) obtained by dividing the weight average molecular weight (Mw) by the number average molecular weight (Mn), of each polymer, were calculated under the following conditions, based on the calibration curve.
Columns: two TSK gel GMHHR-H (20) HT (7.8 mm I. D.×30 cm) columns
Mobile phase: 1,2,4-trichlorobenzene
Detector: RI
Column temperature: 160° C.
Sample concentration: 1 mg/ml
Calibration curve: polystyrene

### [Measurement of Melt Tension]

The melt tension (mN) of each microporous membrane was measured using a Capilograph manufactured by Toyo Seiki Co., Ltd., under the following conditions.
Capillary: diameter 1.0 mm, length 20 mm
Cylinder extrusion speed: 2 mm/min
Take-up speed: 60 m/min
Temperature: 230° C.

### [Measurement of Pentad Fraction]

The pentad fraction of polypropylene was calculated by the peak-height method, from the ¹³C-NMR spectrum assigned based on the description in Polymer Analysis Handbook (Edited by the Japan Society for Analytical Chemistry). The measurement of the ¹³C— NMR spectrum was carried out using JEOL-ECZ 500, by melting polypropylene pellets in o-dichlorobenzene-d, under the conditions of a measurement temperature of 145° C. and a cumulative number 25,000 times.

[Measurement of Thickness (μm)]

The thickness (μm) of the substrate was measured using a Digimatic indicator IDC112, manufactured by Mitutoyo Corporation, at room temperature 23±2° C. The thickness of each microporous layer was calculated from the image data by cross-sectional SEM, acquired by the evaluation method of the area average major pore diameter to be described later.

### [Measurement of Porosity (%)]

A sample having a size of a 10 cm×10 cm square was cut out from the separator or each microporous layer, the volume (cm³) and the mass (g) of the sample were measured, and the porosity was calculated from these measured values and the density (g/cm³) using the following equation.

Porosity(%)=(volume−mass/density)/volume×100

[Measurement of Air Permeability (sec/100 cm³)]

The air resistance (sec/100 cm³) of the substrate was measured, using a Gurley air permeability tester in accordance with JIS P-8117, and the measured air resistance was divided by the thickness and multiplied by 16 to calculate the air permeability in terms of a thickness of 16 μm.

[Measurement of Air Permeability (sec/100 cm³) after High Temperature Treatment]

The substrate was cut out in a square of 100 mm×100 mm in the MD and TD directions to obtain a sample, the sample was placed in a hot air dryer (DF1032, manufactured by Yamato Science Co., Ltd.) with the ends of the four sides of the square being fixed to a metal frame, and subjected to a heat treatment at 140° C. for 30 minutes in the atmosphere, under normal pressure. After the heat treatment, the sample was taken out of the hot air dryer, allowed to cool at room temperature for 10 minutes, and the substrate was removed from the metal frame. Thereafter, the air resistance (sec/100 cm³) of the substrate was measured using a Gurley air permeability tester in accordance with JIS P-8117, and the measured air resistance was divided by the thickness and multiplied by 16 to calculate the air permeability after high temperature treatment (in terms of a thickness of 16 μm). The rate of change in air permeability was determined in accordance with the following equation:

Rate of change in air permeability(%)={air permeability(sec/100 cm³)after heating−air permeability(sec/100 cm³)before heating}÷air permeability(sec/100 cm³)after heating×100

### [Measurement of TD Heat Shrinkage (%)]

The substrate was cut out in a square of 50 mm×50 mm in the MD and TD directions to obtain a sample, the sample was placed in a hot air dryer (DF1032, manufactured by Yamato Science Co., Ltd.), and subjected to a heat treatment at 150° C. for one hour in the atmosphere, under normal pressure. After the heat treatment, the sample was taken out of the hot air dryer, allowed to cool at room temperature for 10 minutes, and then the dimensional shrinkage was determined. Each sample was placed on a copy paper or the like, so as not to adhere to the inner wall of the dryer, etc., and such that the samples were not fused with each other.

Heat shrinkage(%):(dimension before heating(mm)−dimension after heating(mm))/(dimension before heating(mm))×100

### [Measurement of Area Average Major Pore Diameter]

### (1) Area Average Major Pore Diameter in an ND-MD Cross Section

The area average major pore diameter in an ND-MD cross section was measured by an image analysis in a cross-sectional SEM observation. The separator was subjected to ruthenium staining as a pretreatment, and an ND-MD cross-sectional sample was prepared by freeze-fracture. The thus prepared cross-sectional sample was fixed with a conductive adhesive agent (carbon-based), on an SEM sample stand for cross-sectional observation, dried, and then subjected to osmium coating as a conductive treatment, using an osmium coater (HPC-30W, manufactured by Vacuum Device Inc.), under the conditions of a voltage application adjustment knob setting of 4.5 and a discharge time of 0.5 seconds, to prepare a microscopic sample. Thereafter, arbitrary three points in the ND-MD cross section of microporous membrane were observed using a scanning electron microscope (S-4800, manufactured by Hitachi High Technologies Inc.), under the conditions of an acceleration voltage of 1 kV, detection signal: LA10, an operational distance of 5 mm and a magnification of 5,000 times.

Each observation image was binarized into resin portions and pore portions, using image processing software, Image J, and the Otsu's method, and the average major diameter of the pore portions was calculated. At this time, micropore portions which are present extending across each captured region and the region outside the captured region, as well as pores having a pore area of 0.001 μm 2 or less were excluded from the objects to be measured. The average diameter was calculated from the areas of the respective pores based on the area average. In order to avoid overestimating the contribution of extremely small pores, the average value was calculated based on the area average which is the weighted average of the areas of the respective pores, not on the number average obtained by dividing by the number of pores.

### (2) Area Average Major Pore Diameter on Substrate Surface

The area average major pore diameter on surface of the substrate was measured by an image analysis in the SEM observation of the surface. When the substrate has an optional coating layer(s) on the surface(s) thereof, the coating layer(s) was/were removed by peeling off the coating layer(s) by hand after immersing the substrate in acetone for 3 minutes, as a pretreatment. Thereafter, the substrate was washed with water, and then dried overnight at room temperature. The thus prepared sample was fixed with a conductive adhesive agent (carbon-based), on an SEM sample stand for surface observation, dried, and then subjected to osmium coating as a conductive treatment, using an osmium coater (HPC-30W, manufactured by Vacuum Device Inc.), under the conditions of a voltage application adjustment knob setting of 4.5 and a discharge time of 0.5 seconds, to prepare a microscopic sample. Thereafter, arbitrary three points on surface of the corresponding microporous membrane were observed using a scanning electron microscope (S-4800, manufactured by Hitachi High Technologies Inc.), under the conditions of an acceleration voltage of 1 kV, detection signal: LA10, an operational distance of 5 mm and a magnification of 5,000 times. A region of 20 μm in the MD direction x 3 μm in the ND direction in the resulting image was taken as an observation image. Each observation image was binarized into resin portions and pore portions, using image processing software, Image J, and the Otsu's method, and the average major diameter of the pore portions was calculated. At this time, micropore portions which are present extending across each captured region and the region outside the captured region, as well as pores having a pore area of 0.001 lam 2 or less were excluded from the objects to be measured. The average diameter was calculated from the areas of the respective pores based on the area average.

### [Evaluation of Cycle Capacity Retention Rate and Clogging]

As an electrolytic solution, one obtained by incorporating 1 mol/L of LiPF₆, as a lithium salt, into a mixture of ethylene carbonate and ethyl methyl carbonate in a volume ratio of 1:2 was used.

A lithium/nickel/manganese/cobalt mixed oxide (LiNi_{0.5}Co_{0.2}Mn_{0.3}O₂) as a positive electrode active material, a carbon black powder as a conductive auxiliary agent, and PVDF as a binder were mixed at a mass ratio of the mixed oxide: the conductive auxiliary agent: the binder=100:3.5:3. The resulting mixture was coated on both surfaces of aluminum foils as positive electrode current collectors each having a thickness of 15 μm, dried, and then pressed with a roll press, to prepare double-side coated positive electrodes.

A graphite powder (artificial graphite) having a particle size (D50) of 22 μm, as a negative electrode active material, a binder (poly-styrene-butadiene latex), and carboxymethyl cellulose as a thickener were mixed at a mass ratio of the graphite powder: the binder: the thickener=100:1.5:1.1. The resulting mixture was coated on one surface or both surfaces of copper foils as negative electrode current collectors each having a thickness of 10 μm, the solvent was removed by drying, and then the coated copper foils were pressed with a roll press, to prepare single-side coated negative electrodes or double-side coated negative electrodes.

The thus obtained positive electrodes and negative electrodes were layered with the separators produced as described below interposed therebetween so as to face the respective active materials, in the order of the single-side coated negative electrode/the double-side coated positive electrode/the double-side coated negative electrode/the double-side coated positive electrode/the single-side coated negative electrode, and the edges of the MD of the separators were fixed with a seal. At this time, the microporous layers (A) were disposed so as to face the negative electrodes. Subsequently, the resulting layered member was inserted, in a state where positive and negative electrode terminals installed thereto in a protruding manner, into the interior of a bag (battery exterior) composed of a laminate film obtained by coating both surfaces of an aluminum foil (thickness: 40 μm) with a resin layer. After drying the resultant at 80° C. for 12 hours in the atmosphere, 0.8 mL of the electrolytic solution prepared as described above was injected into the bag, and the bag was vacuum-sealed to prepare a sheet-shaped lithium-ion secondary battery.

The resulting sheet-shaped lithium-ion secondary battery was placed in a thermostatic chamber controlled to 25° C., connected to a charging and discharging device, and left to stand for 16 hours. Subsequently, the battery was subjected to three charge and discharge cycles each consisting of: charging at a constant current of 0.05 C; charging at a constant voltage of 4.35 V for 2 hours after the voltage having reached 4.35 V; and then discharging to 3.0 V at a constant current of 0.2 C; to perform the initial charge and discharge of the battery. The “1 C” refers to a current value in the case of discharging the entire capacity of a battery in one hour.

After the initial charge and discharge described above, the battery was placed in the thermostatic chamber controlled to 25° C. Thereafter, the battery was subjected to 100 charge and discharge cycles each consisting of: charging at a constant current of 1 C; charging at a constant voltage of 4.35 V for one hour after the voltage having reached 4.35 V; and then discharging to 3.0 V at a constant current of 1 C; to perform a battery cycle test.

The value (percentage) obtained by dividing the discharging capacity (mAh) at the 100th cycle by the discharging capacity (mAh) at the 1st cycle was taken as the cycle capacity retention rate. Further, the sheet-shaped lithium-ion secondary battery after the completion of the 100th cycle was disassembled in an argon atmosphere, the separators were taken out, and washed three times by immersion in ethyl methyl carbonate. Thereafter, a region of 1 mm square of the negative electrode-side surface of a separator was observed with a microscope, to confirm the presence or absence of the clogging on the separator surface. When 50% or more of the pores of the separator surface were covered with deposits, the surface was evaluated as being “clogged”; and when 50% or more of the pores of the separator surface were not covered with deposits, the surface was evaluated as being “not clogged”. The confirmation of the presence or absence of the clogging as described above was carried out at 10 locations, and the proportion of the locations evaluated as being “clogged” was calculated.

### [Evaluation of Short Circuits]

Five sheet-shaped lithium-ion secondary batteries were prepared by the method described in the section of the evaluation of the cycle capacity retention rate.

Each resulting sheet-shaped lithium-ion secondary battery was placed in a thermostatic chamber controlled to 25° C., connected to a charging and discharging device, and left to stand for 16 hours. Subsequently, each battery was subjected to three charge and discharge cycles each consisting of: charging at a constant current of 0.05 C; charging at a constant voltage of 4.35 V for 2 hours after the voltage having reached 4.35 V; and then discharging to 3.0 V at a constant current of 0.2 C; to perform the initial charge and discharge of the battery. The “1 C” refers to a current value in the case of discharging the entire capacity of a battery in one hour.

After the initial charge and discharge described above, each sheet-shaped lithium-ion secondary battery was charged at a constant current of 0.5 C and then charged at a constant voltage of 4.5 V for one hour after the voltage had reached 4.5 V, in a state pressurized to 0.5 MPa at 25° C. Thereafter, each battery was left to stand for one hour in an open circuit state. The batteries in which the voltage had not reached 4.5 V even after performing the constant current charging for one hour, and the batteries in which the voltage had decreased to 4.3 V or less within one hour maintained in an open circuit state were evaluated as being “short-circuited”, and the proportion of those evaluated as being “short-circuited” was calculated.

### [Evaluation of Resistance to High Temperature Drying]

As an electrolytic solution, one obtained by incorporating 1 mol/L of LiPF₆, as a lithium salt, into a mixture of ethylene carbonate and ethyl methyl carbonate in a volume ratio of 1:2 was used.

A lithium/nickel/manganese/cobalt mixed oxide (LiNi_{0.5}Co_{0.2}Mn_{0.3}O₂) as a positive electrode active material, a carbon black powder as a conductive auxiliary agent, and PVDF as a binder were mixed at a mass ratio of the mixed oxide: the conductive auxiliary agent: the binder=100:3.5:3. The resulting mixture was coated on both surfaces of aluminum foils as positive electrode current collectors each having a thickness of 15 μm, dried, and then pressed with a roll press, to prepare double-side coated positive electrodes.

A graphite powder (artificial graphite) having a particle size (D50) of 22 μm, as a negative electrode active material, a binder (poly-styrene-butadiene latex), and carboxymethyl cellulose as a thickener were mixed at a mass ratio of the graphite powder: the binder: the thickener=100:1.5:1.1. The resulting mixture was coated on one surface or both surfaces of copper foils as negative electrode current collectors each having a thickness of 10 μm, the solvent was removed by drying, and then the coated copper foils were pressed with a roll press, to prepare single-side coated negative electrodes or double-side coated negative electrodes.

The thus obtained positive electrodes and negative electrodes were layered with the separators produced as described below interposed therebetween so as to face the respective active materials, in the order of the single-side coated negative electrode/the double-side coated positive electrode/the double-side coated negative electrode/the double-side coated positive electrode/the single-side coated negative electrode, and the edges of the MD of the separators were fixed with a seal. At this time, the microporous layers (A) were disposed so as to face the negative electrodes. Subsequently, the resulting layered member was inserted, in a state where positive and negative electrode terminals installed thereto in a protruding manner, into the interior of a bag (battery exterior) composed of a laminate film obtained by coating both surfaces of an aluminum foil (thickness: 40 μm) with a resin layer. After drying the resultant at 140° C. for 30 minutes in the atmosphere, 0.8 mL of the electrolytic solution prepared as described above was injected into the bag, and the bag was vacuum-sealed to prepare a sheet-shaped lithium-ion secondary battery which had been subjected to a high temperature drying treatment. The resulting sheet-shaped lithium-ion secondary battery was placed in a thermostatic chamber controlled to 25° C., connected to a charging and discharging device, and left to stand for 16 hours. Subsequently, the battery was charged at a constant current of 0.5 C, to confirm whether the battery is capable or incapable of being charged. In a normal secondary battery, 4.35 V which is a target voltage is reached within 3 hours; whereas in a battery whose ion conductivity is lost, the voltage rapidly increases to 5 V or more in several minutes, to activate an emergency stop. If the emergency stop had been activated, the battery was evaluated as being incapable of being charged.

### Example 1

### [Preparation of Microporous Layers]

As the resins of the microporous layer (A), 95 wt % of a polypropylene resin having a high molecular weight (shown in Table 1 as “PP1”; MFR (230° C.)=1.0 g/10 min, density=0.91 g/cm³) and 5 wt % of a random copolymer-type elastomer of ethylene and butene (shown in Table 1 as “C2C4”) were dry blended, to obtain a resin material. The resulting resin material was melted in a 2.5-inch extruder, and supplied to both outer layers of a two-kind-three-layer co-extrusion T die, using a gear pump. Further, as the resin of the microporous layer (B), a polypropylene resin having a high molecular weight (shown in Table 1 as “PP1”; MFR (230° C.)=1.0 g/10 min, density=0.91 g/cm³) was melted in a 2.5-inch extruder, and supplied to the inner layer of the above-described two-kind-three-layer co-extrusion T die, using a gear pump. The temperature of the T die was set to 220° C., the molten polymers were extruded from the T die, and then the resin extrudate was taken up on a roll while being cooled with blown air, to obtain a precursor sheet having an A/B/A layer structure with a thickness of about 17 μm. At this time, the lip width in the TD direction of the T die was set to 500 mm, the lip-to-lip distance (lip clearance) of the T die was set to 2.4 mm, and the extrusion was carried out at an extrusion rate of 6 kg/h.

Subsequently, the resulting precursor was placed in a dryer, and subjected to an annealing treatment at 120° C. for 20 minutes. Thereafter, the annealed precursor was cold stretched 20% at room temperature, the stretched film was placed in an oven controlled to 125° C. without allowing it to shrink, hot stretched 140%, and then relaxed 15%, to obtain a substrate having a three-layer structure composed of layers A/B/A.

### Examples 2 to 4, Examples 7 to 16 and Comparative Examples 1 to 8

Respective microporous membranes were obtained in same manner as in Example 1, except that the raw materials and the stretching conditions shown in Tables 1 to 3 were used, and the resulting separators were evaluated. In Tables 1 to 3, “PP1”, “PP2”, “PP3”, “PP4” and “PP5” represent polypropylene resins shown in Table 4. In Tables 1 to 3, “SEPS” represents a styrene-ethylene/propylene-styrene block copolymer. Further, in Tables 1 to 3, “PE” represents polyethylene (MFR (190° C.)=0.4 g/10 min).

### Example 5

A two-kind-two-layer co-extrusion T die was installed instead of the two-kind-three-layer co-extrusion T die, and the raw materials shown in Table 1 were used to perform film formation under the same conditions as in Example 1, to obtain a precursor sheet having an A/B layer structure with a thickness of about 17 μm.

Subsequently, the resulting precursor was placed in a dryer, and subjected to an annealing treatment at 120° C. for 20 minutes. Thereafter, the annealed precursor was cold stretched 20% at room temperature, the stretched film was placed in an oven controlled to 125° C. without allowing it to shrink, hot stretched 140%, and then relaxed 15%, to obtain a substrate having a two-layer structure composed of layers A/B.

### Example 6

A three-kind-three-layer co-extrusion T die was installed instead of the two-kind-three-layer co-extrusion T die, and the raw materials shown in Table 1 were used to perform film formation under the same conditions as in Example 1, to obtain a precursor sheet having an A/B/C layer structure with a thickness of about 17 μm.

Subsequently, the resulting precursor was placed in a dryer, and subjected to an annealing treatment at 120° C. for 20 minutes. Thereafter, the annealed precursor was cold stretched 20% at room temperature, the stretched film was placed in an oven controlled to 125° C. without allowing it to shrink, hot stretched 140%, and then relaxed 15%, to obtain a substrate having a three-layer structure composed of layers A/B/C.

### Example 17

As an electrolytic solution, one obtained by incorporating 1 mol/L of LiPF₆, as a lithium salt, into a mixture of ethylene carbonate and ethyl methyl carbonate in a volume ratio of 1:2 was used.

A lithium iron phosphate compound represented by LiFePO₄ as a positive electrode active material, a carbon black powder as a conductive auxiliary agent, and PVDF as a binder were mixed at a mass ratio of the mixed oxide: the conductive auxiliary agent: the binder=92:5:3. The resulting mixture was coated on both surfaces of aluminum foils as positive electrode current collectors each having a thickness of 15 μm, dried, and then pressed with a roll press, to prepare double-side coated positive electrodes.

A graphite powder (artificial graphite) having a particle size (D50) of 22 μm, as a negative electrode active material, a binder (poly-styrene-butadiene latex), and carboxymethyl cellulose as a thickener were mixed at a mass ratio of the graphite powder: the binder: the thickener=100:1.5:1.1. The resulting mixture was coated on one surface or both surfaces of copper foils as negative electrode current collectors each having a thickness of 10 μm, the solvent was removed by drying, and then the coated copper foils were pressed with a roll press, to prepare single-side coated negative electrodes or double-side coated negative electrodes.

The thus obtained positive electrodes and negative electrodes were layered with the separators produced in Example 10 interposed therebetween so as to face the respective active materials, in the order of the single-side coated negative electrode/the double-side coated positive electrode/the double-side coated negative electrode/the double-side coated positive electrode/the single-side coated negative electrode, and the edges of the MD of the separators were fixed with a seal. At this time, the microporous layers (A) were disposed so as to face the negative electrodes. Subsequently, the resulting laminate was inserted, in a state where positive and negative electrode terminals installed thereto in a protruding manner, into the interior of a bag (battery exterior) composed of a laminate film obtained by coating both surfaces of an aluminum foil (thickness: 40 μm) with a resin layer. After drying the resultant at 80° C. for 12 hours in the atmosphere, 0.8 mL of the electrolytic solution prepared as described above was injected into the bag, and the bag was vacuum-sealed to prepare a sheet-shaped lithium-ion secondary battery whose positive electrodes contain the lithium iron phosphate compound.

The resulting sheet-shaped lithium-ion secondary battery whose positive electrodes contain the lithium iron phosphate compound was placed in a thermostatic chamber controlled to 25° C., connected to a charging and discharging device, and left to stand for 16 hours. Subsequently, the battery was subjected to three charge and discharge cycles each consisting of: charging at a constant current of 0.05 C; charging at a constant voltage of 3.65 V for 2 hours after the voltage having reached 3.65 V; and then discharging to 2.40 V at a constant current of 0.2 C; to perform the initial charge and discharge of the battery. The “1 C” refers to a current value in the case of discharging the entire capacity of a battery in one hour.

After the initial charge and discharge described above, the battery was placed in the thermostatic chamber controlled to 25° C. Thereafter, the battery was subjected to 10 charge and discharge cycles each consisting of: charging at a constant current of 1 C; charging at a constant voltage of 3.65 V for one hour after the voltage having reached 3.65 V; and then discharging to 2.40 V at a constant current of 1 C. It has been confirmed that the resulting battery was capable of being charged and discharged in a favorable manner.

TABLE 1-1

| | | Example 1 | Example 2 | Example 3 | Example 4 |
|---|---|---|---|---|---|
| Layered structure of separator | | A/B/A | A/B/A | A/B/A | A/B/A |
| Layer A | Composition (wt %) | PP1 (95) | PP1 (95) | PP1 (95) | PP1 (95) |
| | | C2C4 (5) | SEPS (5) | SEPS (5) | SEPS (5) |
| | MFR of Layer A | 1.41 | 1.39 | 1.38 | 1.37 |
| | Thickness (μm) | 5 | 5 | 5 | 4 |
| | Area average major pore diameter (nm) | 228 | 276 | 285 | 268 |
| | Major pore diameter ratio A/B | 1.25 | 1.39 | 1.65 | 1.57 |
| Layer B | Composition (wt %) | PP1 (100) | PP1 (100) | PP2 (100) | PP2 (100) |
| | MFR of Layer B | 1.05 | 1.05 | 0.56 | 0.56 |
| | Thickness (μm) | 5 | 5 | 5 | 4 |
| | Area average major pore diameter (nm) | 183 | 198 | 173 | 171 |
| | Major pore diameter ratio B/A | 0.8 | 0.72 | 0.61 | 0.64 |
| Layer C | Composition (wt %) | — | — | — | — |
| | MFR of Layer C | — | — | — | — |
| | Thickness (μm) | — | — | — | — |
| | Area average major pore diameter (nm) | — | — | — | — |
| | Major pore diameter ratio C/B | — | — | — | — |
| Surface pore diameter | Major pore diameter S_{X} of surface X | — | — | — | — |
| | Major pore diameter S_{Y} of surface Y | — | — | — | — |
| | Major pore diameter ratio (S_{X}/S_{Y}) | — | — | — | — |
| Stretching condition | Cold stretching ratio | 20% | 20% | 20% | 20% |
| Separator | Thickness (μm) | 15 | 15 | 15 | 12 |
| | Porosity | 43.4% | 44.7% | 43.6% | 43.5% |
| | TD heat shrinkage | 0.2% | 0.1% | 0.2% | 0.2% |
| | Air permeability (sec) | 236 | 231 | 244 | 198 |
| | Air permeability after high temperature | 240 | 233 | 245 | 202 |
| | treatment (sec) | | | | |
| | Rate of increase in air permeability | 1.7% | 0.9% | 0.4% | 2.0% |
| | after high temperature treatment | | | | |
| Resistance to high | Capable or incapable of being charged | Capable | Capable | Capable | Capable |
| temperature drying | after high temperature drying | | | | |
| Battery performance | Post-cycle capacity retention rate | 77% | 79% | 82% | 83% |
| | Post-cycle clogging | 0% | 0% | 0% | 0% |
| | Short circuit evaluation | 0% | 0% | 0% | 0% |

TABLE 1-2

| | | Example 5 | Example 6 | Example 7 | Example 8 |
|---|---|---|---|---|---|
| Layered structure of separator | | A/B | A/B/C | A/B/A | A/B/A |
| Layer A | Composition (wt %) | PP1 (95) | PP1 (95) | PP2 (95) | PP2 (95) |
| | | SEPS (5) | SEPS (5) | SEPS (5) | SEPS (5) |
| | MFR of Layer A | 1.39 | 1.39 | 0.63 | 0.64 |
| | Thickness (μm) | 8 | 5 | 5 | 5 |
| | Area average major pore diameter (nm) | 275 | 272 | 161 | 381 |
| | Major pore diameter ratio A/B | 1.63 | 1.31 | 1.25 | 1.36 |
| Layer B | Composition (wt %) | PP2 (100) | PP1 (100) | PP2 (100) | PP2 (100) |
| | MFR of Layer B | 0.56 | 1.05 | 0.56 | 0.56 |
| | Thickness (μm) | 8 | 5 | 5 | 5 |
| | Area average major pore diameter (nm) | 169 | 208 | 129 | 280 |
| | Major pore diameter ratio B/A | 0.61 | 0.76 | 0.8 | 0.73 |
| Layer C | Composition (wt %) | — | PP2 (100) | — | — |
| | MFR of Layer C | — | 0.56 | — | — |
| | Thickness (μm) | — | 5 | — | — |
| | Area average major pore diameter (nm) | — | 175 | — | — |
| | Major pore diameter ratio C/B | — | 0.84 | — | — |
| Surface pore diameter | Major pore diameter S_{X} of surface X | 241 | 257 | — | — |
| | Major pore diameter S_{Y} of surface Y | 160 | 158 | — | — |
| | Major pore diameter ratio (S_{X}/S_{Y}) | 1.51 | 1.63 | — | — |
| Stretching condition | Cold stretching ratio | 20% | 20% | 40% | 12% |
| Separator | Thickness (μm) | 16 | 15 | 15 | 15 |
| | Porosity | 44.1% | 43.8% | 45.8% | 43.3% |
| | TD heat shrinkage | 0.3% | 0.3% | 0.3% | 0.3% |
| | Air permeability (sec) | 267 | 248 | 187 | 228 |
| | Air permeability after high temperature | 264 | 246 | 189 | 225 |
| | treatment (sec) | | | | |
| | Rate of increase in air permeability | −1.1% | −0.8% | 1.1% | −1.3% |
| | after high temperature treatment | | | | |
| Resistance to high | Capable or incapable of being charged | Capable | Capable | Capable | Capable |
| temperature drying | after high temperature drying | | | | |
| Battery performance | Post-cycle capacity retention rate | 84% | 83% | 74% | 83% |
| | Post-cycle clogging | 0% | 0% | 10% | 0% |
| | Short circuit evaluation | 0% | 20% | 0% | 20% |

TABLE 2-1

| | | Example 9 | Example 10 | Example 11 | Example 12 |
|---|---|---|---|---|---|
| Layered structure of separator | | A/B/A | A/B/A | A/B/A | A/B/A |
| Layer A | Composition (wt %) | PP2 (95) | PP2 (95) | PP2 (95) | PP2 (95) |
| | | SEPS (5) | SEPS (5) | SEPS (5) | SEPS (5) |
| | MFR of Layer A | 0.66 | 0.64 | 0.63 | 0.65 |
| | Thickness (μm) | 5 | 5 | 5 | 5 |
| | Area average major pore diameter (nm) | 447 | 289 | 419 | 206 |
| | Major pore diameter ratio A/B | 1.37 | 1.9 | 1.66 | 1.86 |
| Layer B | Composition (wt %) | PP2 (100) | PP3 (100) | PP3 (100) | PP3 (100) |
| | MFR of Layer B | 0.56 | 0.34 | 0.34 | 0.34 |
| | Thickness (μm) | 5 | 5 | 5 | 5 |
| | Area average major pore diameter (nm) | 327 | 152 | 252 | 111 |
| | Major pore diameter ratio B/A | 0.73 | 0.53 | 0.6 | 0.54 |
| Layer C | Composition (wt %) | — | — | — | — |
| | MFR of Layer C | — | — | — | — |
| | Thickness (μm) | — | — | — | — |
| | Area average major pore diameter (nm) | — | — | — | — |
| | Major pore diameter ratio C/B | — | — | — | — |
| Surface pore | Major pore diameter S_{X} of surface X | — | — | — | — |
| diameter | Major pore diameter S_{Y} of surface Y | — | — | — | — |
| | Major pore diameter ratio (S_{X}/S_{Y}) | — | — | — | — |
| Stretching | Cold stretching ratio | 10% | 25% | 12% | 35% |
| condition | | | | | |
| Separator | Thickness (μm) | 15 | 15 | 15 | 15 |
| | Porosity | 44.8% | 45.1% | 42.3% | 45.2% |
| | TD heat shrinkage | 0.1% | 0.3% | 0.1% | 0.2% |
| | Air permeability (sec) | 207 | 213 | 236 | 212 |
| | Air permeability after high temperature | 210 | 218 | 237 | 209 |
| | treatment (sec) | | | | |
| | Rate of increase in air permeability after | 1.4% | 2.3% | 0.4% | −1.4% |
| | high temperature treatment | | | | |
| Resistance to high | Capable or incapable of being charged | Capable | Capable | Capable | Capable |
| temperature | after high temperature drying | | | | |
| drying | | | | | |
| Battery | Post-cycle capacity retention rate | 84% | 82% | 84% | 76% |
| performance | Post-cycle clogging | 0% | 0% | 0% | 0% |
| | Short circuit evaluation | 20% | 0% | 20% | 0% |

TABLE 2-2

| | | Example 13 | Example 14 | Example 15 | Example 16 |
|---|---|---|---|---|---|
| Layered structure of separator | | A/B/A | A/B/A | A/B/A | A/B/A |
| Layer A | Composition (wt %) | PP2 (95) | PP2 (95) | PP1 (100) | PP1 (80) |
| | | SEPS (5) | SEPS (5) | | PE (20) |
| | MFR of Layer A | 0.63 | 0.64 | 1.05 | 1.41 |
| | Thickness (μm) | 5 | 5 | 5 | 5 |
| | Area average major pore diameter (nm) | 277 | 212 | 280 | 285 |
| | Major pore diameter ratio A/B | 2.1 | 1.62 | 1.18 | 1.19 |
| Layer B | Composition (wt %) | PP3 (100) | PP4 (100) | PP2 (100) | PP2 (100) |
| | MFR of Layer B | 0.34 | 0.45 | 0.56 | 0.56 |
| | Thickness (μm) | 5 | 5 | 5 | 5 |
| | Area average major pore diameter (nm) | 132 | 131 | 238 | 239 |
| | Major pore diameter ratio B/A | 0.48 | 0.62 | 0.85 | 0.84 |
| Layer C | Composition (wt %) | — | — | — | — |
| | MFR of Layer C | — | — | — | — |
| | Thickness (μm) | — | — | — | — |
| | Area average major pore diameter (nm) | — | — | — | — |
| | Major pore diameter ratio C/B | — | — | — | — |
| Surface pore | Major pore diameter S_{X} of surface X | — | — | — | — |
| diameter | Major pore diameter S_{Y} of surface Y | — | — | — | — |
| | Major pore diameter ratio (S_{X}/S_{Y}) | — | — | — | — |
| Stretching | Cold stretching ratio | 30% | 30% | 20% | 20% |
| condition | | | | | |
| Separator | Thickness (μm) | 15 | 15 | 15 | 15 |
| | Porosity | 42.6% | 45.5% | 45.9% | 42.2% |
| | TD heat shrinkage | 0.2% | 0.3% | 0.1% | 0.2% |
| | Air permeability (sec) | 231 | 197 | 187 | 249 |
| | Air permeability after high temperature | 224 | 204 | 190 | 392 |
| | treatment (sec) | | | | |
| | Rate of increase in air permeability after | −3.0% | 3.6% | 1.6% | 57.4% |
| | high temperature treatment | | | | |
| Resistance to high | Capable or incapable of being charged | Capable | Capable | Capable | Capable |
| temperature | after high temperature drying | | | | |
| drying | | | | | |
| Battery | Post-cycle capacity retention rate | 80% | 78% | 80% | 76% |
| performance | Post-cycle clogging | 0% | 0% | 0% | 0% |
| | Short circuit evaluation | 0% | 0% | 20% | 0% |

TABLE 3-1

| | | Comparative | Comparative | Comparative | Comparative |
|---|---|---|---|---|---|
| | | Example 1 | Example 2 | Example 3 | Example 4 |
| Layered structure of separator | | A/B/A | A/B/A | A/B/A | A/B/A |
| Layer A | Composition (wt %) | PP1 (100) | PP1 (100) | PP1 (100) | PP3 (100) |
| | MFR of Layer A | 1.05 | 1.05 | 1.06 | 0.35 |
| | Thickness (μm) | 5 | 5 | 5 | 5 |
| | Area average major pore diameter (nm) | 191 | 222 | 170 | 109 |
| | Major pore diameter ratio A/B | 1.02 | 0.36 | 0.71 | 0.96 |
| Layer B | Composition (wt %) | PP1 (100) | PE (100) | PP1 (95) | PP3 (100) |
| | | | | SEPS (5) | |
| | MFR of Layer B | 1.05 | −0.45 | 1.38 | 0.34 |
| | Thickness (μm) | 5 | 5 | 5 | 5 |
| | Area average major pore diameter (nm) | 188 | 617 | 239 | 113 |
| | Major pore diameter ratio B/A | 0.98 | 2.78 | 1.41 | 1.04 |
| Layer C | Composition (wt %) | — | — | — | — |
| | MFR of Layer C | — | — | — | — |
| | Thickness (μm) | — | — | — | — |
| | Area average major pore diameter (nm) | — | — | — | — |
| | Major pore diameter ratio C/B | — | — | — | — |
| Surface pore | Major pore diameter S_{X} of surface X | 177 | 201 | — | — |
| diameter | Major pore diameter S_{Y} of surface Y | 174 | 198 | — | — |
| | Major pore diameter ratio (S_{X}/S_{Y}) | 1.02 | 1.02 | — | — |
| Stretching condition | Cold stretching ratio | 20% | 20% | 20% | 40% |
| Separator | Thickness (μm) | 15 | 15 | 15 | 15 |
| | Porosity | 44.2% | 44.3% | 43.8% | 44.8% |
| | TD heat shrinkage | 0.4% | 0.5% | 0.4% | 0.3% |
| | Air permeability (sec) | 275 | 286 | 288 | 238 |
| | Air permeability after high temperature | 280 | >5000 | 292 | 234 |
| | treatment (sec) | | | | |
| | Rate of increase in air permeability after | 1.8% | >1500% | 1.4% | −1.7% |
| | high temperature treatment | | | | |
| Resistance to high | Capable or incapable of being charged | Capable | Incapable | Capable | Capable |
| temperature drying | after high temperature drying | | | | |
| Battery performance | Post-cycle capacity retention rate | 59% | 64% | 63% | 59% |
| | Post-cycle clogging | 30% | 20% | 30% | 90% |
| | Short circuit evaluation | 20% | 20% | 20% | 0% |

TABLE 3-2

| | | Comparative | Comparative | Comparative | Comparative |
|---|---|---|---|---|---|
| | | Example 5 | Example 6 | Example 7 | Example 8 |
| Layered structure of separator | | A/B/A | A/B/A | A/B/A | A/B/A |
| Layer A | Composition (wt %) | PP1 (100) | PP1 (100) | PE (100) | PE (100) |
| | MFR of Layer A | 1.06 | 1.05 | −0.45 | −0.43 |
| | Thickness (μm) | 5 | 5 | 5 | 5 |
| | Area average major pore diameter (nm) | 383 | 92 | 624 | 654 |
| | Major pore diameter ratio A/B | 1.01 | 1.05 | 2.03 | 1.05 |
| Layer B | Composition (wt %) | PP1 (100) | PP5 (100) | PP1 (100) | PE (100) |
| | MFR of Layer B | 1.06 | 0.93 | 1.07 | −0.43 |
| | Thickness (μm) | 5 | 5 | 5 | 5 |
| | Area average major pore diameter (nm) | 379 | 88 | 308 | 625 |
| | Major pore diameter ratio B/A | 0.99 | 0.96 | 0.49 | 0.96 |
| Layer C | Composition (wt %) | — | — | — | — |
| | MFR of Layer C | — | — | — | — |
| | Thickness (μm) | — | — | — | — |
| | Area average major pore diameter (nm) | — | — | — | — |
| | Major pore diameter ratio C/B | — | — | — | — |
| Surface pore | Major pore diameter S_{X} of surface X | — | — | — | — |
| diameter | Major pore diameter S_{Y} of surface Y | — | — | — | — |
| | Major pore diameter ratio (S_{X}/S_{Y}) | — | — | — | — |
| Stretching condition | Cold stretching ratio | 10% | 40% | 20% | 20% |
| Separator | Thickness (μm) | 15 | 15 | 15 | 15 |
| | Porosity | 45.6% | 44.1% | 42.7% | 46.4% |
| | TD heat shrinkage | 0.3% | 0.3% | 0.4% | 0.4% |
| | Air permeability (sec) | 227 | 259 | 295 | 207 |
| | Air permeability after high temperature | 222 | 264 | >5000 | >5000 |
| | treatment (sec) | | | | |
| | Rate of increase in air permeability after | −2.2% | 1.9% | >1500% | >2300% |
| | high temperature treatment | | | | |
| Resistance to high | Capable or incapable of being charged | Capable | Capable | Incapable | Incapable |
| temperature drying | after high temperature drying | | | | |
| Battery performance | Post-cycle capacity retention rate | 79% | 49% | 59% | 57% |
| | Post-cycle clogging | 0% | 90% | 0% | 0% |
| | Short circuit evaluation | 40% | 0% | 40% | 60% |

TABLE 4

| | | MFR | | |
|---|---|---|---|---|
| | Density | (g/10 | Mw | MWD |
| | (g/cm³) | minutes) | — | — |
| PP1 | 0.91 | 1 | 650000 | 5.9 |
| PP2 | 0.91 | 0.5 | 810000 | 4.2 |
| PP3 | 0.91 | 0.3 | 940000 | 13 |
| PP4 | 0.91 | 0.4 | 850000 | 4.9 |
| PP5 | 0.91 | 0.9 | 690000 | 5.4 |

### Example 18

### [Preparation of Microporous Layers]

As the resins of the microporous layer (A), 95% by weight of a polypropylene resin having a high molecular weight (shown in Table 5 as “PP1”, MFR (230° C.)=1.0 g/10 min, density=0.91 g/cm³) and 5% by weight of a styrene-ethylene/propylene-styrene block copolymer (shown in Table 5 as “SEPS”) were dry blended, to obtain a resin material. The resulting resin material was melted in a 2.5-inch extruder, and supplied to the outer layer on one side of a two-kind-two-layer co-extrusion T die, using a gear pump. Further, as the resin of the microporous layer (B), a polypropylene resin having a high molecular weight (shown in Table 5 as “PP2”; MFR (230° C.)=0.5 g/10 min, density=0.91 g/cm³) was melted in a 2.5-inch extruder, and supplied to the outer layer on the other side of the above-described two-kind-two-layer co-extrusion T die, using a gear pump. The temperature of the T die was set to 220° C., the molten polymers were extruded from the T die, and then the resin extrudate was taken up on a roll while being cooled with blown air, to obtain a precursor sheet having an A/B layer structure with a thickness of about 17 lam. At this time, the lip width in the TD direction of the T die was set to 500 mm, the lip-to-lip distance (lip clearance) of the T die was set to 2.4 mm, and the extrusion was carried out at an extrusion rate of 6 kg/h.

Subsequently, the resulting precursor was placed in a dryer, and subjected to an annealing treatment at 120° C. for 20 minutes. Thereafter, the annealed precursor was cold stretched 20% at room temperature, the stretched film was placed in an oven controlled to 125° C. without allowing it to shrink, hot stretched 140%, and then relaxed 15%, to obtain a substrate having a two-layer structure composed of layers A/B. In the resulting substrate, the surface (constituting the surface (X)) on the side of the microporous layer (A) has a larger pore diameter, and the surface (constituting the surface (Y)) on the side of the microporous layer (B) has a smaller pore diameter.

### Example 19

Respective microporous membranes were obtained in same manner as in Example 18, except that the raw materials shown in Table 5 were used, and the resulting separator was evaluated. In Table 5, “C2C4” represents a random copolymer-type elastomer of ethylene and butene.

### Example 20

A three-kind-three-layer co-extrusion T die was installed instead of the two-kind-two-layer co-extrusion T die, and the raw materials shown in Table 5 were used to perform film formation under the same conditions as in Example 18, to obtain a precursor sheet having an A/C/B layer structure with a thickness of about 17 μm.

Subsequently, the resulting precursor was placed in a dryer, and subjected to an annealing treatment at 120° C. for 20 minutes. Thereafter, the annealed precursor was cold stretched 20% at room temperature, the stretched film was placed in an oven controlled to 125° C. without allowing it to shrink, hot stretched 140%, and then relaxed 15%, to obtain a separator substrate having a three-layer structure composed of layers A/C/B. In the resulting substrate, the surface (constituting the surface (X)) on the side of the microporous layer (A) has a larger pore diameter, and the surface (constituting the surface (Y)) on the side of the microporous layer (B) has a smaller pore diameter.

### Comparative Examples 9 and 10

A two-kind-three-layer co-extrusion T die was installed instead of the two-kind-two-layer co-extrusion T die, and the raw materials shown in Table 5 were used to perform film formation under the same conditions as in Example 18, to obtain precursor sheets having an A/C/B layer structure with a thickness of about 17 μm. In Table 5, “PE” represents polyethylene (MFR (230° C.)=0.4 g/10 min).

Subsequently, the resulting precursors were placed in a dryer, and subjected to an annealing treatment at 120° C. for 20 minutes. Thereafter, the annealed precursors were cold stretched 20% at room temperature, the stretched films were placed in an oven controlled to 125° C. without allowing them to shrink, hot stretched 140%, and then relaxed 15%, to obtain separator substrates having a three-layer structure composed of layers A/C/B.

TABLE 5

| | | | | | Comparative | Comparative |
|---|---|---|---|---|---|---|
| | | Example 18 | Example 19 | Example 20 | Example 9 | Example 10 |
| Layered structure of separator | | A/B | A/B | A/C/B | A/C/B | A/C/B |
| Layer A | Composition (wt %) | PP1 (95) | PP1 (95) | PP1 (95) | PP1 (100) | PP1 (100) |
| (Surface X) | | SEPS (5) | C2C4 (5) | SEPS (5) | | |
| Layer C | Composition (wt %) | — | — | PP1 (100) | PP1 (100) | PE (100) |
| Layer B | Composition (wt %) | PP2 (100) | PP2 (100) | PP2 (100) | PP1 (100) | PP1 (100) |
| (Surface Y) | | | | | | |
| Separator | Major pore diameter S_{X} of surface X | 241 | 214 | 257 | 177 | 201 |
| | (nm) | | | | | |
| | Major pore diameter S_{Y} of surface Y | 160 | 174 | 158 | 174 | 198 |
| | (nm) | | | | | |
| | Major pore diameter ratio (S_{X}/S_{Y}) | 1.51 | 1.23 | 1.63 | 1.02 | 1.02 |
| | Separator thickness (μm) | 16 | 12 | 15 | 15 | 15 |
| | Porosity | 44.10% | 43.60% | 43.80% | 44.20% | 44.30% |
| | Air permeability (sec) | 267 | 203 | 248 | 275 | 286 |
| | TD heat shrinkage | 0.30% | 0.20% | 0.30% | 0.40% | 0.50% |
| | Air permeability after high | 264 | 196 | 246 | 280 | >10000 |
| | temperature treatment (sec) | | | | | |
| Resistance to | Capable or incapable of being charged | Capable | Capable | Capable | Capable | Incapable |
| high | after high temperature drying | | | | | |
| temperature | | | | | | |
| drying | | | | | | |
| Battery | Post-cycle capacity retention rate | 84% | 81% | 83% | 59% | 64% |
| performance | Post-cycle clogging | 0% | 0% | 0% | 30% | 20% |
| | Short circuit evaluation | 0% | 0% | 20% | 20% | 20% |

### INDUSTRIAL APPLICABILITY

The separator for an electric storage device according to the present disclosure can be suitably used as a separator for an electric storage device, for example, a lithium-ion secondary battery.

1-23. (canceled)

24. A separator for an electric storage device, comprising a substrate comprising:
a microporous layer (A) containing 70 wt % or more of polypropylene; and
a microporous layer (B) containing 70 wt % or more of polypropylene,
wherein the area average major pore diameter in an ND-MD cross section of the pores included in the microporous layer (B) is not more than 0.95 times the area average major pore diameter in an ND-MD cross section of the pores included in the microporous layer (A).

25. The separator for an electric storage device according to claim 24, wherein the area average major pore diameter in an ND-MD cross section of the pores included in the microporous layer (B) is not less than 0.30 times and not more than 0.90 times the area average major pore diameter in an ND-MD cross section of the pores included in the microporous layer (A).

26. The separator for an electric storage device according to claim 24, wherein the substrate has a rate of change in air permeability, when the substrate is heated at 140° C. for 30 minutes in the atmosphere with the ends thereof being immobilized, of 100% or less; wherein the area average major pore diameter in an ND-MD cross section of the pores included in the microporous layer (A) is 100 nm or more and 600 nm or less; or wherein the microporous layer (A) constitutes each of the outermost layers on both sides of the substrate.

27. The separator for an electric storage device according to claim 24, wherein the substrate further comprises a microporous layer (C) containing 50 wt % or more of a polyolefin.

28. The separator for an electric storage device according to claim 27, wherein the area average major pore diameter in an ND-MD cross section of the pores included in the microporous layer (C) is not less than 0.20 times and not more than 0.90 times the area average major pore diameter in an ND-MD cross section of the pores included in the microporous layer (B).

29. The separator for an electric storage device according to claim 27, wherein the substrate comprises a structure in which the microporous layer (A), the microporous layer (B) and the microporous layer (C) are layered in the order mentioned.

30. The separator for an electric storage device according to claim 24, wherein the substrate comprises a structure in which the microporous layer (A), the microporous layer (B) and the microporous layer (A) are layered in the order mentioned; or
wherein, when the surface of the substrate on the side of the microporous layer (A) is defined as a first porous surface (X), and the surface thereof on the side opposite to the first porous surface (X) is defined as a second porous surface (Y), the area average major pore diameter (S_{X}) of the pores included in the first porous surface (X) is not less than 1.05 times and not more than 10 times the area average major pore diameter (S_{Y}) of the pores included in the second porous surface (Y).

31. The separator for an electric storage device according to claim 30, wherein the average major pore diameter (S_{X}) is 80 nm or more and 600 nm or less.

32. The separator for an electric storage device according to claim 24, wherein the substrate has a heat shrinkage in the width direction, as measured after being heated at 150° C. for one hour, of −1.0% or more and 3.0% or less.

33. An electric storage device comprising a positive electrode, a negative electrode, and the separator for an electric storage device according to claim 24.

34. The electric storage device according to claim 33, wherein the microporous layer (A) is disposed facing the negative electrode side.

35. The electric storage device according to claim 33, wherein the positive electrode contains lithium iron phosphate as a positive electrode active material.

36. A separator for an electric storage device, comprising a substrate which contains 70% by weight or more of a polyolefin, and which has a first porous surface (X), and a second porous surface (Y) on the side opposite to the first porous surface (X), wherein the area average major pore diameter (S_{X}) of the pores included in the first porous surface (X) is not less than 1.05 times and not more than 10 times the area average major pore diameter (S_{Y}) of the pores included in the second porous surface (Y).

37. The separator for an electric storage device according to claim 36, wherein the average major pore diameter (S_{X}) is 80 nm or more and 600 nm or less.

38. The separator for an electric storage device according to claim 36, wherein the polyolefin is polypropylene; or
wherein the substrate has a heat shrinkage in the width direction, as measured after being heated at 150° C. for one hour, of −1.0% or more and 3.0% or less.

39. An electric storage device comprising a positive electrode, a negative electrode, and the separator for an electric storage device according to claim 36.

40. The electric storage device according to claim 39, wherein the first porous surface (X) is disposed facing the negative electrode side; or
wherein the positive electrode contains lithium iron phosphate as a positive electrode active material.

41. A microporous membrane, comprising a substrate comprising:
a microporous layer (A) containing 70 wt % or more of polypropylene; and
a microporous layer (B) containing 70 wt % or more of polypropylene,
wherein the area average major pore diameter in an ND-MD cross section of the pores included in the microporous layer (B) is not more than 0.95 times the area average major pore diameter in an ND-MD cross section of the pores included in the microporous layer (A).

42. The separator for an electric storage device according to claim 25, wherein the substrate has a rate of change in air permeability, when the substrate is heated at 140° C. for 30 minutes in the atmosphere with the ends thereof being immobilized, of 100% or less; wherein the area average major pore diameter in an ND-MD cross section of the pores included in the microporous layer (A) is 100 nm or more and 600 nm or less; or wherein the microporous layer (A) constitutes each of the outermost layers on both sides of the substrate.

43. The separator for an electric storage device according to claim 25, wherein the substrate comprises a structure in which the microporous layer (A), the microporous layer (B) and the microporous layer (A) are layered in the order mentioned; or wherein, when the surface of the substrate on the side of the microporous layer (A) is defined as a first porous surface (X), and the surface thereof on the side opposite to the first porous surface (X) is defined as a second porous surface (Y), the area average major pore diameter (S_{X}) of the pores included in the first porous surface (X) is not less than 1.05 times and not more than 10 times the area average major pore diameter (S_{Y}) of the pores included in the second porous surface (Y).

44. The separator for an electric storage device according to claim 37, wherein the polyolefin is polypropylene; or wherein the substrate has a heat shrinkage in the width direction, as measured after being heated at 150° C. for one hour, of −1.0% or more and 3.0% or less.

45. The separator for an electric storage device according to claim 28, wherein the substrate comprises a structure in which the microporous layer (A), the microporous layer (B) and the microporous layer (C) are layered in the order mentioned.

46. The separator for an electric storage device according to claim 25, wherein the substrate has a heat shrinkage in the width direction, as measured after being heated at 150° C. for one hour, of −1.0% or more and 3.0% or less.

47. The electric storage device according to claim 34 wherein the positive electrode contains lithium iron phosphate as a positive electrode active material.

48. An electric storage device comprising a positive electrode, a negative electrode, and the separator for an electric storage device according to claim 37.
